(19) United States
(12) Patent Application Publication
(10) Pub. No.: US 2014/0244196 A1
(43) Pub. Date: Aug. 28, 2014

(54) MEASURING APPARATUS

(71) Applicant: CANON KABUSHIKI KAISHA, Tokyo (JP)

(72) Inventors: Ippei Uchida, Utsunomiya-shi (JP); Yoshiyuki Okada, Sakura-shi (JP)

(73) Assignee: CANON KABUSHIKI KAISHA, Tokyo (JP)

(21) Appl. No.: 14/190,419

(22) Filed: Feb. 26, 2014

(30) Foreign Application Priority Data
Feb. 26, 2013 (JP) 2013-036398

(51) Int. Cl. G01B 9/02

(52) U.S. Cl. CPC G01B 9/02084
USPC 702/94

(57) ABSTRACT

Provided is a measuring apparatus that measures a position or a displacement of a target object by calculating a phase difference between a reference signal and a measuring signal. The measuring apparatus includes a demodulation unit configured to demodulate the measuring signal by the first frequency to thereby generate a demodulated signal including the component of the second frequency, a cyclic error component, and a harmonic component occurred due to demodulation; a decimation filter configured to remove the harmonic component from the demodulated signal to thereby output a signal including the component of the second frequency and the cyclic error component; and a measuring signal correcting unit configured to detect and remove the cyclic error component included in the output signal from the decimation filter.

### BACKGROUND OF THE INVENTION

1. Field of the Invention

The present invention relates to an apparatus for measuring a position or a displacement of a target object.

2. Description of the Related Art

In a precise machine working or an inspection process, a position or a displacement of a target object needs to be measured on the precision order of nm to μm, and a length measuring apparatus using the principle of an interferometer is prevalently used. As such a length measuring apparatus, a heterodyne interferometer is used for high-precision length measurement. The heterodyne interferometer detects a reference signal modulated by a frequency fr and a measuring signal which is modulated by the frequency fr and includes position information of a target object. Since this measuring signal includes a frequency shift±fd caused by a Doppler shift according to a moving speed of the target object in addition to a shift of the frequency fr due to modulation, its frequency is (fr±fd). By calculating a frequency difference between these reference signal and measuring signal, ±fd is detected. By integrating the frequency difference±fd by a time, a phase difference is calculated, and a position or a displacement of the target object is calculated from the calculated phase difference.

However, due to reflection, scattering, and incompleteness of light from optical components included in the interferometer, error signals (cyclic error components) which are cyclic to the Doppler shift fd may be superimposed on measuring beam from the heterodyne interferometer. Although the cyclic error components vary depending on the layouts and characteristics of the optical components, the cyclic error components may include various frequencies from lower to higher orders like fd/2, −fd, 2fd, 3fd, . . . with respect to the Doppler shift fd. These cyclic error components included in measuring beam from the heterodyne interferometer may lead to deterioration in length-measuring precision. Thus, it is essential that these cyclic error components are removed (reduced) when high-precision length measurement is performed.

Japanese Patent Laid-Open No. 2008-510170 discloses a heterodyne interferometer that removes the above cyclic error components. The heterodyne interferometer detects a reference signal and a measuring signal using, for example, a 120-MHz A/D converter, and performs DFT (Discrete Fourier Transform) calculation at intervals of 10 MHz. Furthermore, the heterodyne interferometer performs CORDIC (Coordinate Rotation Digital Computer) calculation to calculate a phase difference between a reference signal and a measuring signal and measure a position or a displacement of a target object. The heterodyne interferometer detects cyclic error components depending on the Doppler shift fd from the output signal obtained from DFT calculation to thereby generate a removal signal. Then, the heterodyne interferometer removes the cyclic error components of −fd, 0, 2fd, and 3fd by subtracting the removal signal from the output signal from DFT calculation. At this time, a delay occurs in the removal signal by a time required for detecting the cyclic error components and generating the removal signal, resulting in a delay in phase with respect to the cyclic error components. Thus, in the heterodyne interferometer, a delay time required for detecting the cyclic error components and generating the removal signal is given to the output signal from DFT calculation, so that the phases of the cyclic error components and the removal signal are matched. In addition, the heterodyne interferometer switches the presence/absence of the output of the removal signal based on conditions such as a moving speed of a target object, a measuring signal voltage, a cyclic error voltage, a motion period, and the like. Furthermore, Japanese Patent Laid-Open No. 2007-304114 discloses a displacement measuring interferometer that generates a removal signal by detecting cyclic error components using a regression analysis on a length measurement value and then removes cyclic error components by subtracting the removal signal from the length measurement value. The displacement measuring interferometer suspends update of the removal signal when a target object is moving at a low speed, and removes cyclic error components using the removal signal prior to suspension.

However, in the heterodyne interferometer disclosed in Japanese Patent Laid-Open No. 2008-510170, the phases of the measuring signal and the removal signal are matched, and thus, a delay time required for detecting the cyclic error components and generating the removal signal is given to the measuring signal. Thus, when the target object is moving, a length measurement error occurs depending on a delay time and a moving speed. For example, when a moving speed is calculated by time-differentiating the length measurement value and the length measurement error is corrected by the product of the moving speed and the delay time, the noise in the length measurement value increases by time-differentiation, and further increases by the product of the moving speed and the delay time. Consequently, a position or a displacement of the target object cannot be precisely measured due to an increase in noise in the length measurement value. Thus, it is preferable that a delay time to be given to a measuring signal is suppressed to a minimum. In addition, since the heterodyne interferometer switches the presence/absence of the output of the removal signal based on conditions such as a moving speed of a target object, a measuring signal voltage, a cyclic error voltage, and a motion period, a length measurement error may occur in a period during which no removal signal is output.

On the other hand, Japanese Patent Laid-Open No. 2007-304114 does not disclose a method for correcting a delay of a removal signal that has been generated upon detection of cyclic error components and generation of the removal signal. Thus, in the displacement measurement interferometer, the phases of the cyclic error components and the removal signal are not matched, resulting in an occurrence of a length measurement error. In addition, the interferometer suspends update of the removal signal when the average speed of the target object is 0.23 mm/s or less or is multiple times of 49.375 mm/s with ±0.23 mm/s, resulting in an increase in phase error or amplitude error between the cyclic error components and the removal signal. Consequently, a large length measurement error may occur. Furthermore, Japanese Patent Laid-Open No. 2008-510170 and Japanese Patent Laid-Open No. 2007-304114 do not disclose a method for correcting cyclic error components when the motion of the target object is accelerated.

### SUMMARY OF THE INVENTION

The present invention provides a measuring apparatus that is advantageous for measuring a position or a displacement of a target object with high precision.

According to an aspect of the present invention, a measuring apparatus that acquires a reference signal from a reference beam modulated by a first frequency, acquires a measuring signal from a measuring beam further modulated by a second frequency which occurs due to movement of a target object in addition to modulation by the first frequency, and measures a position or a displacement of the target object by calculating a phase difference between the reference signal and the measuring signal, the measuring apparatus comprising: a demodulation unit configured to demodulate the measuring signal by the first frequency to thereby generate a demodulated signal including the component of the second frequency, a cyclic error component depending on the second frequency, and a harmonic component occurred due to demodulation; a decimation filter configured to remove the harmonic component from the demodulated signal to thereby output a signal including the component of the second frequency and the cyclic error component; a measuring signal correcting unit configured to detect and remove the cyclic error component included in the output signal from the decimation filter; a phase calculating unit configured to calculate the phase difference between the reference signal and the measuring signal based on the output signal from the measuring signal correcting unit; and a position calculating unit configured to calculate the position or the displacement of the target object based on the output signal from the phase calculating unit, wherein the measuring signal correcting unit further comprises: a detector configured to detect the cyclic error component; a signal generating unit configured to generate a removal signal for removing the cyclic error component; a removing unit configured to remove the cyclic error component using the removal signal to thereby output the component of the second frequency; and a processing delay correcting unit configured to correct a processing delay of the detector and the signal generating unit.

Further features of the present invention will become apparent from the following description of exemplary embodiments with reference to the attached drawings.

### BRIEF DESCRIPTION OF THE DRAWINGS

FIG. 1 is a diagram illustrating an exemplary configuration of a measuring apparatus according to one embodiment of the present invention.

FIG. 2 is a diagram illustrating a configuration of a signal processing unit according to a first embodiment.

FIG. 3 is a diagram illustrating an exemplary configuration of a Phase Locked Loop (PLL).

FIG. 4 is a diagram illustrating an exemplary configuration of a decimation filter (CIC filter).

FIG. 5 is a graph illustrating an exemplary characteristic of a CIC filter.

FIG. 6 is a graph illustrating an exemplary characteristic of a CIC filter.

FIG. 7 is a diagram illustrating a configuration of a signal generating unit according to the first embodiment.

FIG. 8 is a diagram illustrating a configuration of a signal processing unit according to a second embodiment.

FIG. 9 is a diagram illustrating a configuration of a signal generating unit according to the second embodiment.

FIG. 10 is a diagram illustrating a configuration of a signal processing unit according to a third embodiment.

FIG. 11 is a diagram illustrating a configuration of a signal generating unit according to the third embodiment.

FIG. 12 is a diagram illustrating a configuration of a signal processing unit according to a fourth embodiment.

FIG. 13 is a diagram illustrating a configuration of a filter calculating unit according to the fourth embodiment.

FIG. 14 is a graph illustrating an exemplary characteristic of a CIC filter.

FIG. 15 is a graph illustrating filter switching by a filter calculating unit.

FIG. 16 is a diagram illustrating a configuration of a signal processing unit according to a fifth embodiment.

FIG. 17 is a diagram illustrating a configuration of an amplitude and phase calculating unit according to the fifth embodiment.

FIG. 18 is a graph illustrating an exemplary relationship between acceleration and length measurement error.

### DESCRIPTION OF THE EMBODIMENTS

Hereinafter, preferred embodiments of the present invention will now be described with reference to the accompanying drawings.

### First Embodiment

Firstly, a description will be given of a measuring apparatus according to a first embodiment of the present invention. In particular, it is assumed that the measuring apparatus of the present embodiment acquires a reference signal from reference beam modulated by a first frequency, acquires a measuring signal from a measuring beam further modulated by a second frequency which occurs due to the moving speed of a target object in addition to modulation by the first frequency, and measures a position or a displacement of the target object.

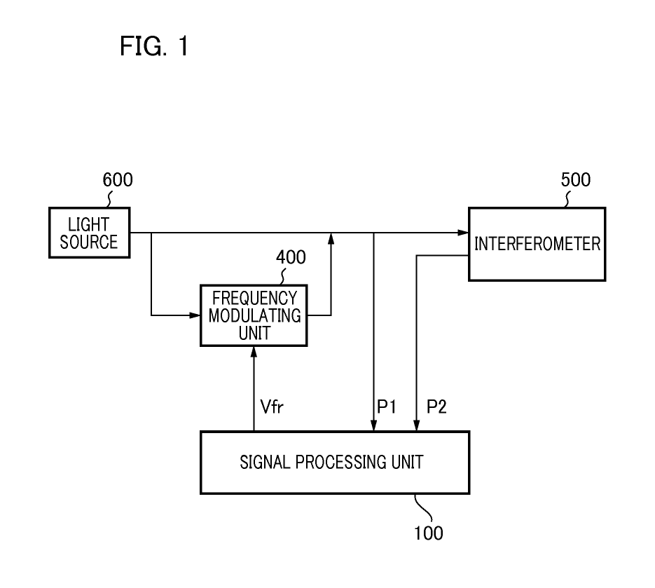

FIG. 1 is a diagram illustrating an exemplary configuration of a measuring apparatus using a heterodyne interferometer according to one embodiment of the present invention. A light source 600 is a laser beam source formed from, for example, an HeNe laser having a wavelength of 632.8 nm, or a DFB laser or VCSEL laser which is a semiconductor laser having a wavelength of from 640 to 2,830 nm. A frequency modulating unit 400 configured to modulate the frequency of light is formed from an AOM (Acousto-Optic Modulator) or the like. Laser beams to irradiate the frequency modulating unit 400 are modulated by a first frequency fr (first angular frequency ωr=2π×fr) by driving the frequency modulating unit 400 by a signal Vfr from a signal processing unit 100 represented by equation (1):

Vfr=Va×sin(2π×fr×t) (1)

where Va is the amplitude of the signal Vfr and t is a time.

One of the laser beams modulated by the first frequency fr enters the signal processing unit 100 as reference beam P1. A target object included in an interferometer 500 is irradiated with the other of the laser beams modulated by the first frequency fr, and reflected light from the target object enters the signal processing unit 100 as measuring beam P2. The measuring beam P2 is further modulated by a second frequency fd (a second angular frequency ωd=2π×fd) due to a frequency shift (Doppler shift) caused by the moving speed of the target object in addition to modulation by the first frequency fr. The reference beam P1 and the measuring beam P2 are represented by equations (2) and (3), respectively:

P1=(A/2)×{sin(ωr×t+θr)+1} (2)

P2=(B/2)×[sin {(ωr+ωd)×t+θd}+1] (3)

where A is a reference beam intensity, B is a measuring beam intensity, ωr is the first angular frequency, ωd is the second angular frequency, θr is the initial phase of the reference beam, and θd is the initial phase of the measuring beam.

The modulation by the second frequency fd occurs in accordance with the moving speed of the target object and the magnitude of the modulation is represented by equation (4):

fd=j×v/λ (4)

where v is the moving speed of the target object, λ is the wavelength of the light source, and j is an order determined by the configuration of the interferometer. For example, when a light source having λ=1.55 μm is used, v=1 m/s, and j=4, fd=2.58 MHz. The modulation by the second frequency fd due to the Doppler shift has a polarity of +fd or −fd in accordance with the moving direction of the target object.

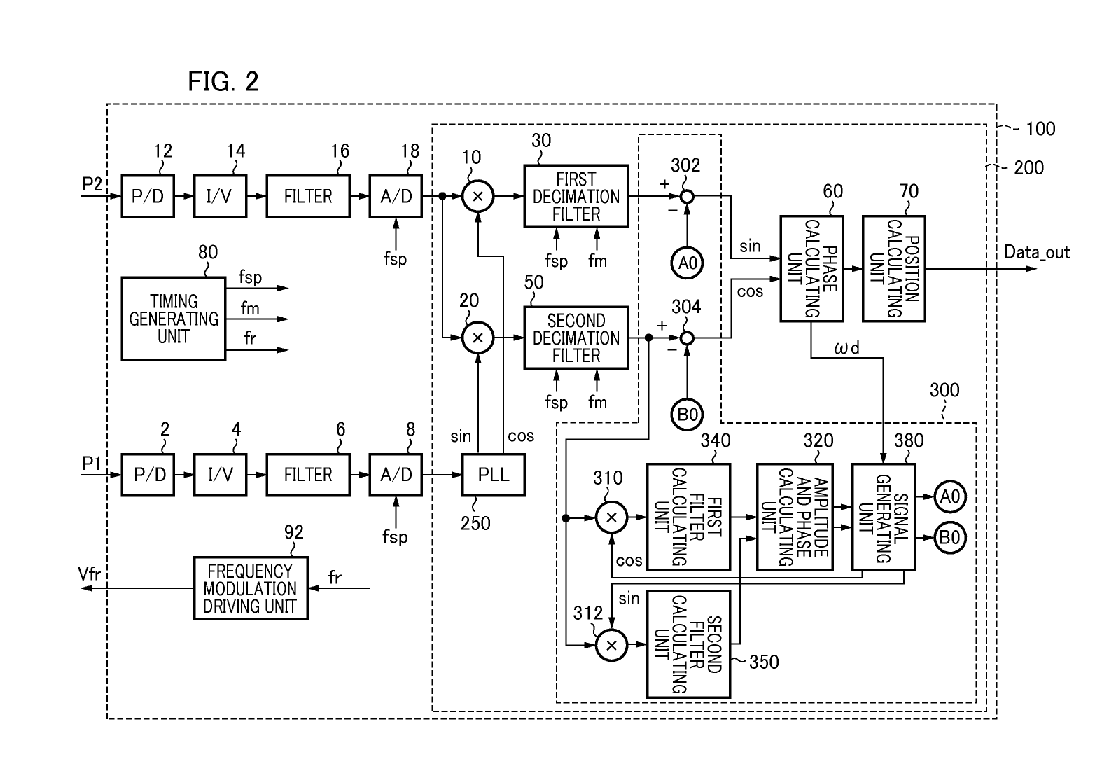

FIG. 2 is a block diagram illustrating a configuration of the signal processing unit 100 according to the present embodiment. The reference beam P1 and the measuring beam P2 are respectively converted into currents by a first light-receiving unit 2 and a second light-receiving unit 12. As the first light-receiving unit 2 and the second light-receiving unit 12, for example, PIN photodiodes, avalanche photodiodes, or the like are used. The outputs from the first light-receiving unit 2 and the second light-receiving unit 12 are input to a first I/V converter 4 and a second I/V converter 14, and are converted into voltages, respectively. Each of the first I/V converter 4 and the second I/V converter 14 is formed from, for example, a resistor and an OP amplifier. The output signals from the first I/V converter 4 and the second I/V converter 14 are respectively input to a first filter 6 and a second filter 16. The first filter 6 and the second filter 16 may be LPFs (Low Pass Filters) to limit a high frequency band, or BPFs (BandPass Filters) to cut a direct current and limit a high frequency band because the reference beam P1 and measuring beam P2 are AC signals. When the first filter 6 and the second filter 16 are BPFs, a DC component is cut off and only the sine signal (sine wave signal) term which is an AC signal is output, so that equations (2) and (3) are modified into equations (5) and (6):

P1′=(A/2)×sin(ωr×t+θr) (5)

P2′=(B/2)×sin {(ωr+ωd)×t+θd} (6)

The output signals from the first filter 6 and the second filter 16 are respectively input to a first A/D converter 8 and a second A/D converter 18, and are sampled at a sampling frequency fsp to be converted into a digital reference signal and a digital measuring signal. The digital signals obtained in this way are input to a digital signal processing unit 200. The digital signal processing unit 200 includes, for example, an FPGA, ASIC, DSP, or the like, which can process the digital signals at high speed. ASIC is an abbreviation for Application Specific Integrated Circuit.

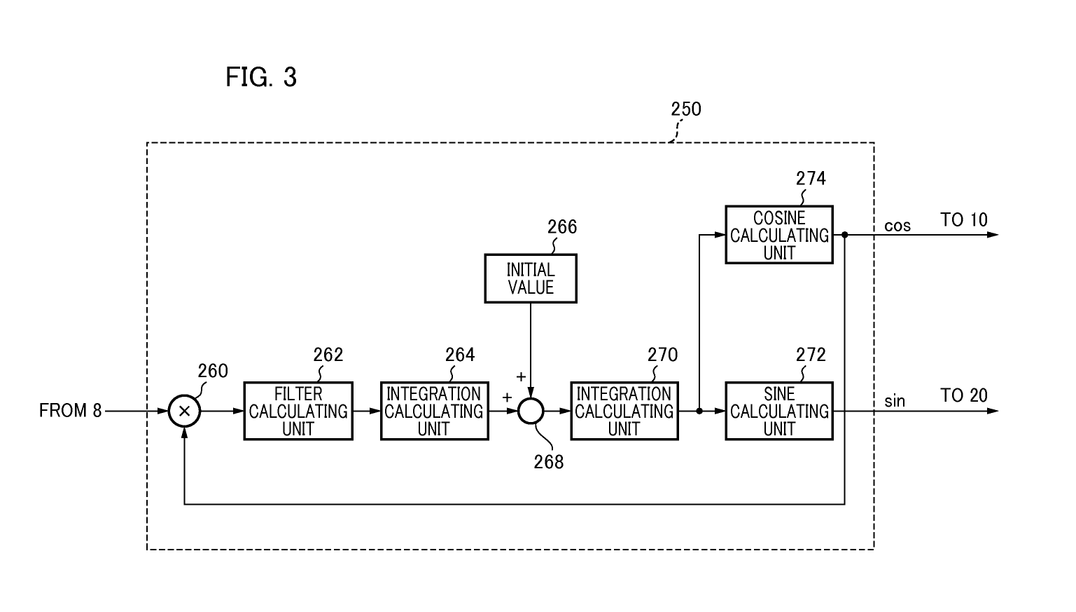

The digital reference signal is input to a PLL (Phase Locked Loop) 250 which synchronizes the phases of input/output signals. FIG. 3 is a block diagram illustrating an exemplary configuration of the PLL 250. Firstly, the digital reference signal is input to a phase comparator 260 (phase detector, Phase Frequency Comparator). The phase comparator 260 includes, for example, a multiplier. The output signal from the phase comparator 260 is input to a filter calculating unit 262 to remove harmonic components included in the output signal from the phase comparator 260. The output signal from the filter calculation unit 262 is input to an integration calculating unit 264. An integration calculation by the integration calculating unit 264 is made for the purpose of integration control required to set an output deviation of the phase comparator 260 to be zero, and the integration calculating unit 264 may be configured to execute stable control as proportional-integration control. The output signal from the integration calculating unit 264 is input to an adder 268, and is added to an initial value 266. The initial value 266 is set to an initial value corresponding to the first frequency fr. A group of an integration calculating unit 270 and a sine calculating unit 272 and a group of the integration calculating unit 270 and a cosine calculating unit 274 are generating units that generate a sine signal and a cosine signal (cosine wave signal). Note that the generating units correspond to, for example, VCOs (Voltage Controlled Oscillators). The operations of these generation units are represented by equations (7) and (8):

(Sine signal)=sin {(∫Vᵢ+Vₙ)dt} (7)

(Cosine signal)=cos {(∫Vᵢ+V₀)dt} (8)

where Vᵢ is an output signal from the integration calculating unit 264 and V₀ is the output signal of the initial value 266.

The sine calculating unit 272 and the cosine calculating unit 274 store, for example, sine (sine wave) and cosine (cosine wave) values obtained in advance in a memory as a table. The sine calculating unit 272 and the cosine calculating unit 274 may also be configured to generate a sine signal and a cosine signal with reference to the table in accordance with values in { } of equations (7) and (8). A memory capacity necessary for a sine signal amplitude range of 12 bits and a time resolution of 10 bits (×1024) is 12 bits×1024=12.288 kbits. A memory capacity necessary for a sine signal amplitude range of 16 bits and a time resolution of 12 bits (×4096) is 16 bits×4096=65.536 kbits. These memory capacities can be easily implemented by using a memory incorporated in an FPGA, ASIC, DSP, or the like.

The output signal from the cosine calculating unit 274 is fed back to the phase comparator 260, and the sine and cosine signals are generated such that the aforementioned integration calculating unit 264 sets the output deviation of the phase comparator 260 to be zero. Since the output deviation becomes zero, the frequencies and phases of a digital reference signal P1′ and an output signal P1_sin from the sine calculating unit 272 that is given by equation (7) are perfectly synchronized. Also, an output signal P1_cos from the cosine calculating unit 274 that is given by equation (8) becomes a synchronization signal having a 90° phase difference. The output signal P1_sin and the output signal P1_cos are represented by equations (9) and (10), respectively:

P1_sin=Vb×sin(ωr×t+θr) (9)

P1_cos=Vb×cos(ωr×t+θr) (10)

where Vb is an amplitude.

Referring back to FIG. 2, the cosine signal P1_cos and the sine signal P1_sin which are synchronized with the digital reference signal generated by the PLL 250 are used for demodulating a digital measuring signal P2′ by a first synchronous detecting unit 10 and a second synchronous detecting unit 20. The first synchronous detecting unit 10 and the second synchronous detecting unit 20 are demodulation units which are configured by, for example, multipliers. At this time, based on equations (6), (9), and (10), the demodulated signals obtained by the first synchronous detecting unit 10 and the second synchronous detecting unit 20 are represented by equations (11) and (12), respectively;

$$\begin{matrix}\begin{matrix}P {2}^{′} \times P 1 \_cos = ( B / 2 ) \times sin \{ ( ω r + ω d ) \times t + θ d \} \times Vb \times \\ cos ( ω r \times t + θ r ) \\ = ( B \times Vb / 4 ) \times [ sin ( ω d \times t + θ d - θ r ) + \\ sin \{ ( 2 ω r + ω d ) \times t + θ d + θ r \} ]\end{matrix} & ( 11 ) \\ \begin{matrix}P {2}^{′} \times P 1 \_sin = ( B / 2 ) \times sin \{ ( ω r + ω d ) \times t + θ d \} \times Vb \times \\ sin ( ω r \times t + θ r ) \\ = ( B \times Vb / 4 ) \times [ cos ( ω d \times t + θ d - θ r ) - \\ cos \{ ( 2 ω r + ω d ) \times t + θ d + θ r \} ]\end{matrix} & ( 12 )\end{matrix}$$

The first terms on the right sides of equations (11) and (12) are respectively a sine signal and a cosine signal that have components of the second angular frequency ωd that have been generated in accordance with the moving speed of the target object. The second terms on the right sides of equations (11) and (12) are respectively a sine signal and a cosine signal having harmonic components of an angular frequency (2ωr+ωd) that have been generated in the first synchronous detecting unit 10 and the second synchronous detecting unit 20. In other words, the first synchronous detecting unit 10 and the second synchronous detecting unit 20 demodulate the measuring signal by the first angular frequency ωr, so that a sine signal and a cosine signal having the signal components of the second angular frequency ωd and the harmonic components of the angular frequency (2ωr+ωd) are output.

The demodulated signals obtained by the first synchronous detecting unit 10 and the second synchronous detecting unit 20 are respectively input to a first decimation filter 30 and a second decimation filter 50. In order to decrease the calculation load of digital signal processing, the first decimation filter 30 and the second decimation filter 50 perform filtering at a decimation frequency to attenuate harmonic components having the angular frequency (2ωr+ωd) that have been generated in the first synchronous detecting unit 10 and the second synchronous detecting unit 20.

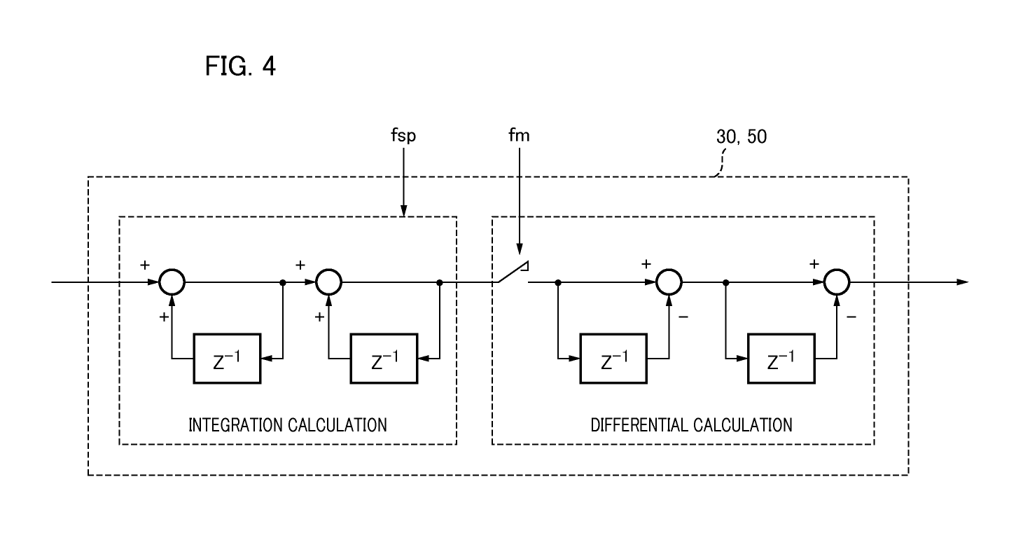

FIG. 4 is a block diagram illustrating an exemplary configuration of the first decimation filter 30 and the second decimation filter 50. As shown in FIG. 4, each of the first decimation filter 30 and the second decimation filter 50 may be a CIC filter (Cascaded Integrator-Comb Filter). The CIC filter performs integration calculation at the sampling frequency fsp and differential calculation at a decimation frequency fm. In this case, the transfer function H(f) of the first decimation filter 30 and the second decimation filter 50 is represented by equation (13):

|H(f)|=|{sin(π×D×f/fsp)/sin(n×f/fsp/m)}^{N}| (13)

where D is a delay difference (1 or 2), m is a decimation ratio (an integer not less than 2), and N is the number of integrator and differentiator stages. Note that FIG. 4 shows a configuration of a CIC filter when N=2.

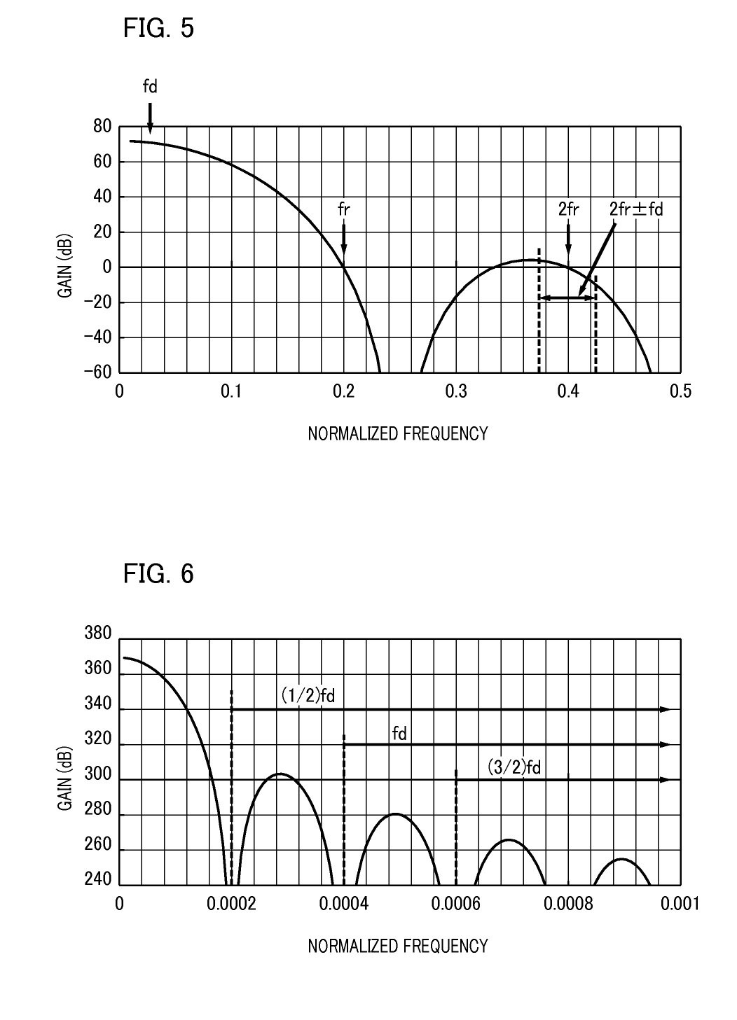

FIG. 5 is a graph illustrating the characteristic of the CIC filter when D=2, m=2, and N=6. When the sampling frequency fsp=100 MHz, a signal frequency capable of digital signal processing is 50 MHz. Thus, in FIG. 5, the horizontal axis indicates the ratio of a signal frequency which actually undergoes digital signal processing to the sampling frequency of 100 MHz as a normalized frequency. Since m=2, the decimation frequency fm=50 MHz. In this case, the signal frequency which undergoes digital signal processing is ½ of the decimation frequency, that is, 25 MHz. In FIG. 5, a notch characteristic in which the gain abruptly attenuates appears at the normalized frequency=0.25, that is, 25 MHz. FIG. 5 shows the case where the first frequency fr=20 MHz and the second frequency fd=2.58 MHz. The frequencies of harmonic components generated by the first synchronous detecting unit 10 and the second synchronous detecting unit 20 are (2fr+fd)=40±2.58 MHz. This reveals that the removal rate with respect to fd is 60 dB or greater, so that sufficient removal rate can be achieved.

Referring back to FIG. 2, cyclic error components included in the output signals from the first decimation filter 30 and the second decimation filter 50 are removed by adder-subtractors 302 and 304 serving as removing units using the removal signals (a first removal signal A0 and a second removal signal B0) generated by a signal generating unit 380. Then, the output signals from the adder-subtractors 302 and 304 are input to a phase calculating unit 60 and the output signal from the phase calculating unit 60 is input to a position calculating unit 70. A frequency calculating unit (not shown) which may be included in the phase calculating unit 60 calculates the change amount of a phase difference between the reference signal and the measuring signal or the change amount of the position of the target object based on the output signals from the adder-subtractors 302 and 304 to thereby calculate the second angular frequency ωd from the change amount. Note that a frequency calculating unit configured to calculate the second angular frequency ωd may also be included in the position calculating unit 70. The phase calculating unit 60 performs arctangent calculation represented by equation (14) using the output signals from the adder-subtractors 302 and 304:

(Phase difference)=tan⁻¹[B×Vb/4×sin(ωd×t+θd−θr)/{B×Vb/4×cos(ωd×t+θd−θr)}]=tan⁻¹{sin(ωd×t+θd−θr)/cos(ωd×t+d−θr)}=ωd×t+θd−θr (14).

A phase difference between the digital reference signal and the digital measuring signal is calculated by calculation represented by equation (14). The position calculating unit 70 converts the phase difference calculated by the phase calculating unit 60 into a position or displacement. For example, a position or displacement L of the target object is represented by equation (15) based on equation (4):

$$\begin{matrix}L = \int ( v ) d t \\ = ( λ / j ) \times \int ( fd ) d t \\ = \{ ( λ / j ) / ( 2 n ) \} \times θ\end{matrix} \qquad ( 15 )$$

where θ is a phase difference.

From equation (15), a position coefficient (λ/j) is (λ/j)=387.5 nm when λ=1.55 μm and j=4. This represents that the position or displacement becomes L=387.5 nm for the phase difference θ=2π. The time differentiation of the phase difference in equation (14) indicates a value corresponding to the second frequency fd. Here, the second angular frequency ωd corresponding to the second frequency fd is represented by equation (16) as described above:

ωd=2π×fd (16)

On the other hand, the time differentiation of the position or displacement in equation (15) represents the moving speed of the target object, so that the second angular frequency ωd can be calculated using equations (4) and (16). While FIG. 2 shows an example in which the second angular frequency ωd is calculated by the phase calculating unit 60 and then is output to the signal generating unit 380, the second angular frequency ωd may also be calculated by the position calculating unit 70.

Then, timing frequencies fsp, fm, and fr to be output to the first A/D converter 8, the second A/D converter 18, the first decimation filter 30, the second decimation filter 50, and a frequency modulation driving unit 92 are generated by a timing generating unit 80.

Here, due to reflection, scattering, and the like of light from optical components included in the interferometer, cyclic length measurement errors depending on the Doppler shift fd occur on measuring beam P2 from the interferometer. The frequencies of cyclic error components vary depending on the layouts and characteristics of the optical components, and may often include various cyclic error components from lower to higher orders like fd/2, 2fd, 3fd, . . . (ωd/2, 2ωd, 3ωd, . . . ) with respect to the Doppler shift fd. The cyclic error components cause length measurement errors in the output signal from the position calculating unit 70. Thus, in the present embodiment, a measuring signal correcting unit 300 detects and removes the cyclic error components of the angular frequencies (n×ωd, n=½, 2, 3, . . . : hereinafter referred to as “nωd”) included in the demodulated signals obtained by the first synchronous detecting unit 10 and the second synchronous detecting unit 20. While FIG. 2 shows an example in which the output signal from the second decimation filter 50 is used in detection of the cyclic error components, the output signal from the first decimation filter 30 may also be used.

The first synchronous detecting unit 10 and the second synchronous detecting unit 20 remove a signal component of the first angular frequency ωr by performing demodulation by the first angular frequency ωr. Consequently, a sine signal and a cosine signal having the signal components of the second angular frequency ωd, the cyclic error components of the angular frequencies nωd, and the harmonic components of the angular frequencies 2ωr+ωd and 2ωr+nωd are output. Since these harmonic components are high frequency components, these harmonic components are removed by the first decimation filter 30 and the second decimation filter 50. Here, when Vn is an amplitude and θn is an initial phase, cyclic error components C1 and C2 included in the output signals from the first decimation filter 30 and the second decimation filter 50 are represented by equations (17) and (18):

C1(t)=Vn×sin(nωd×t+θn) (1.7)

C2(t)=Vn×cos(nωd×t+θn) (18)

The cyclic error component C2 included in the output signal from the second decimation filter 50 is demodulated by a third synchronous detecting unit 310 and a fourth synchronous detecting unit 312 using a cosine signal and a sine signal having the components of the angular frequencies nωd from the signal generating unit 380. Thus, the third synchronous detecting unit 310 and the fourth synchronous detecting unit 312 output the demodulated signals in equations (19) and (20):

$$\begin{matrix}( Output from third synchronous detecting unit 310 ) = Vn \times cos ( n ω d \times t + θ n ) \times cos ( n ω d \times t ) = Vn / 2 \times \{ cos ( θ n ) + cos ( 2 \times n ω d \times t + θ n ) \} & ( 19 ) \\ ( Output from fourth synchronous detecting unit 312 ) = Vn \times cos ( n ω d \times t + θ n ) \times sin ( n ω d \times t ) = Vn / 2 \times \{ - sin ( θ n ) + sin ( 2 \times n ω d \times t + θ n ) \} & ( 20 )\end{matrix}$$

At this time, the signal components of the second angular frequency ωd included in the output signal from the second decimation filter 50 are also demodulated, and the components of the angular frequency ωd±nωd are also output. However, the components of the angular frequency ωd±nωd are removed by a first filter calculating unit 340 and a second filter calculating unit 350, and thus, are not included in equations (19) and (20) for ease of explanation. Furthermore, the demodulated signals represented by equations (19) and (20) are respectively input to the first filter calculating unit 340 and the second filter calculating unit 350, and the harmonic components of the second terms on the right sides of equations (19) and (20) are also removed. Thus, the output signals from the first filter calculating unit 340 and the second filter calculating unit 350 are finally represented by equations (21) and (22), respectively:

(Output from first filter calculating unit 340)=Vn/2×cos(θn) (21)

(Output from second filter calculating unit 350)=−Vn/2×sin(θn) (22)

Note that the first filter calculating unit 340 and the second filter calculating unit 350 may be LPFs (Low Pass Filters) or may also be decimation filters using CIC filters or the like.

Hereinafter, consider the case where the amplitudes Vn and the initial phases θn of cyclic error components included in demodulated signals are detected when a light source of λ=1.55 μm is used, j=4, fr=20 MHz, fd=20 kHz to 5 MHz, that is, a moving speed v of the target object=0.00775 to 1.94 m/s. Assume that the sampling frequency fsp=100 MHz, and a decimation frequency fm=50 MHz by the second decimation filter 50 after demodulation by ωr. The output signals from the third synchronous detecting unit 310 and the fourth synchronous detecting unit 312 are represented by the following three components. In other words, the three components are the DC components having information of the amplitudes Vn and the initial phases 8n of the first terms on the right sides of equations (19) and (20), the harmonic components of the angular frequency (2×nωd) of the second terms on the right sides of equations (19) and (20), and the components of the angular frequency (ωd±nωd) occurred due to demodulation of the signal components of the second angular frequency ωd. Since the amplitudes Vn and the initial phases θn of the cyclic error components to be detected are included in the DC components, unnecessary frequency components are removed by the first filter calculating unit 340 and the second filter calculating unit 350. For example, when n=½, the output signal from the second decimation filter 50 consists of the signal component of the second angular frequency ωd and the cyclic error component of the angular frequency (½)ωd. At this time, upon demodulation by the angular frequency (½)ωd in the third synchronous detecting unit 310 and the fourth synchronous detecting unit 312, the frequency components which appear in the output signals from the synchronous detecting units 310 and 312 are direct current, (½)ωd, ωd, and (3/2)ωd. In other words, the first filter calculating unit 340 and the second filter calculating unit 350 remove the frequency components of (½)ωd, ωd, and (3/2) ωd.

Here, consider the case where the first filter calculating unit 340 and the second filter calculating unit 350 further employ CIC filters having the characteristic as shown in FIG. 6. Note that the CIC filters are configured by setting D=2, m=2500, and N=5. Since the decimation frequency fm by the second decimation filter 50 is 50 MHz, a signal frequency capable of digital signal processing is 25 MHz. Thus, in FIG. 6, the horizontal axis indicates the ratio of a signal frequency which actually undergoes digital signal processing to the decimation frequency fm as a normalized frequency. Since the CIC filters are configured by setting m=2500, the decimation frequency fm1 is 20 kHz. Thus, the signal frequency which undergoes digital signal processing is ½ of the decimation frequency fm1, that is, 10 kHz. For this reason, as shown in FIG. 6, a notch characteristic in which the gain abruptly attenuates appears at the normalized frequency=0.0002, that is, 10 kHz. Thus, the angular frequency (½)ωd (10 kHz to 2.5 MHz), the angular frequency ωd (20 kHz to 5 MHz), and the angular frequency (3/2)ωd (30 kHz to 7.5 MHz) to be removed with respect to the DC components to be detected can obtain a sufficient removal rate of 60 dB or greater.

The output signals from the first filter calculating unit 340 and the second filter calculating unit 350 represented by equations (21) and (22) are input to an amplitude and phase calculating unit 320 that constitutes a detector for detecting cyclic error components. The amplitude and phase calculating unit 320 executes calculation of equations (23) and (24) to thereby output amplitudes AMP and phases OFS.

$$\begin{matrix}( Amplitude AMP ) = √ [ {\{ Vn / 2 \times cos ( θ n ) \}}^{2} + {\{ - Vn / 2 \times sin ( θn ) \}}^{2} ] \times 2 = Vn & ( 23 ) \\ ( Phase OFS ) = atan [ \{ - Vn / 2 \times sin ( θ n ) \} / \{ Vn / 2 \times cos ( θn ) \} ] \times ( - 1 ) = atan \{ sin ( θ n ) / cos ( θ n ) \} = θ n & ( 24 )\end{matrix}$$

With the above calculation, the amplitudes Vn and the initial phases θn of the cyclic error components of the angular frequencies nωd included in the measuring signal can be calculated. In the present embodiment, a definition is made that the detector includes the third synchronous detecting unit 310, the fourth synchronous detecting unit 312, the first filter calculating unit 340, and the second filter calculating unit 350 in addition to the amplitude and phase calculating unit 320.

The signal generating unit 380 generates the first removal signal A0 and the second removal signal B0 of equations (25) and (26), in which the amplitudes and the phases are matched to those of the cyclic error components, for removing the cyclic error components using the calculated amplitudes Vn and initial phases θn.

(First removal signal A0)=Vn×sin(nωd×t+θn) (25)

(Second removal signal B0)=Vn×cos(nωd×t+θn) (26)

The first removal signal A0 and the second removal signal B0 are input to the adder-subtractors 302 and 304 and are used for removing the cyclic error components.

However, a phase delay occurs in the removal signals represented by equations (25) and (26) with respect to the cyclic error components due to a processing delay caused by detection of the cyclic error components and generation of the removal signals. When the angular frequency of the removal signal is given as nωd and the processing delay time is given as τ, the magnitude of the phase delay is nωd×τ. The magnitude of a phase delay with respect to the cyclic error components is n×2π×fd×τ (phase delay value) when the magnitude is represented by using the frequency fd. In other words, the cyclic error components C1 and C2 when a processing delay time τ has elapsed are represented by equations (27) and (28), and it is difficult to remove the cyclic error components with high precision in the removal signals represented by equations (25) and (26).

C1(t+τ)=Vn×sin(nωd×t+nωd×τ+θn) (27)

C2(t+τ)=Vn×cos(nωd×t+nωd×τ+θn) (28)

Here, consider the case where the effect of cyclic error is suppressed to 10% or less. Assume that the amplitudes of the removal signals and the cyclic error components are matched, a phase difference needs to be 0.1 (rad) or less. For example, when n=½, fd=100 kHz (ωd=2πfd), i.e., the cycle of the cyclic error components is 20 μs, and the processing delay time τ is 10 μs, a phase difference between the first removal signal A0 and the second removal signal B0 and the cyclic error components C1 and C2 is π(rad). The phase difference π(rad) is excessively large as compared with 0.1 (rad). In this case, the phases of the removal signals are inverted by 180° with respect to the cyclic error components, resulting in an increase in cyclic error components. Thus, phase delay correction needs to be performed for the above removal signals. Note that the processing delay time τ is divided into a processing delay time τ1 occurred when the cyclic error components are detected and a signal phase-locked to the cyclic error components is generated and a processing delay time τ2 occurred when the phase-locked signal is matched to the amplitudes of the cyclic error components and satisfies the relationship in equation (29):

τ=τ1+τ2 (29)

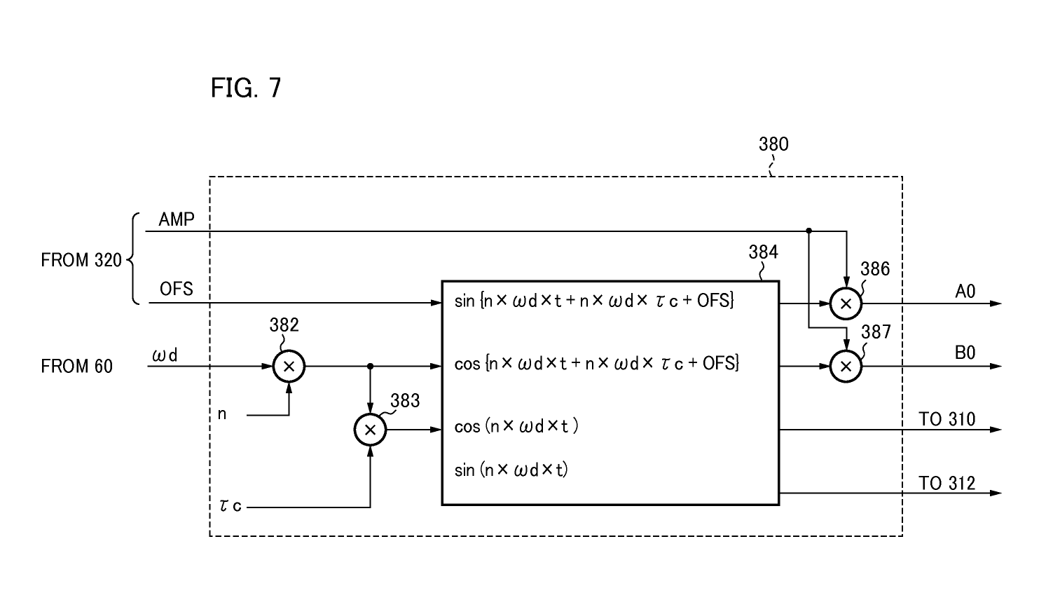

Next, a description will be given of a phase delay correcting method and a signal generating method performed by the signal generating unit 380. FIG. 7 is a block diagram illustrating a configuration of the signal generating unit 380 according to the present embodiment. Firstly, the amplitude and phase calculating unit 320 inputs the amplitudes AMP and the phases OFS of the cyclic error components to the signal generating unit 380. Furthermore, the phase calculating unit 60 (or the position calculating unit 70) inputs the second angular frequency ωd to the signal generating unit 380. A multiplier 382 multiplies the second angular frequency ωd by orders n of cyclic error components, and the multiplication result nωd is input to a multiplier 383 and a sine/cosine generating unit 384. The multiplication result nωd input to the multiplier 383 is multiplied by a correction value τc for the processing delay time τ, and the multiplication result (nωd×τc) is input to the sine/cosine generating unit 384 serving as a processing delay correcting unit. The phase delay (nωd×τ) is corrected as a result of calculation. The sine/cosine generating unit 384 executes calculation of equation (30) based on the input signals from the amplitude and phase calculating unit 320 and the multipliers 382 and 383 to thereby output a sine signal and a cosine signal by using the value as a phase.

$$\begin{matrix}( Phase ) = n ω d \times t + n ω d \times τ c + OFS \\ = n ω d \times t + n ω d \times τ c + θ n\end{matrix} \qquad ( 30 )$$

For example, predetermined sine and cosine values may be stored in a memory as a table, so that a sine signal and a cosine signal may be generated with reference to the table in accordance with the value of the phase in equation (30).

Multipliers 386 and 387 multiply the obtained sine and cosine signals by the amplitude AMP to finally generate removal signals (first removal signal A0 and second removal signal B0). However, a processing delay time τ2 occurs due to the above calculation. Thus, when phase delay correction is performed by setting the correction value τc as equation (31), the first removal signal A0 and the second removal signal B0 are represented by equations (32) and (33) based on the calculation result of the relationship in equation (29).

$$\begin{matrix} τ c = τ 1 + 2 \times τ 2 & ( 31 ) \\ ( First removal signal A 0 ) = Vn \times sin ( n ω d \times t + n ω d \times τ c + θ n - n ω d \times τ 2 ) = Vn \times sin \{ n ω d \times t + n ω d \times ( τ1 + τ2 ) + θ n \} = Vn \times sin ( n ω d \times t + n ω d \times τ + θ n ) & ( 32 ) \\ ( Second removal signal B 0 ) = Vn \times cos ( n ω d \times t + n ω d \times τ c + θ n - n ω d \times τ 2 ) = Vn \times cos \{ n ω d \times t + n ω d \times ( τ1 + τ2 ) + θ n \} = Vn \times cos ( n ω d \times t + n ω d \times τ + θ n ) & ( 33 )\end{matrix}$$

Thus, a phase delay (nωd×τ) of the first removal signal A0 and the second removal signal B0, which are the output signals from the signal generating unit 380, is corrected with respect to the cyclic error components, so that the amplitudes and the phases of the first removal signal A0 and the second removal signal B0 are matched to those of the cyclic error components. In other words, the cyclic error components C1 and C2 represented by equations (27) and (28) can be removed with high precision.

Furthermore, the signal generating unit 380 generates a sine signal and a cosine signal using the output signals nωd from the multiplier 382. These signals are used for demodulating the output signal from the second decimation filter 50 in the third synchronous detecting unit 310 and the fourth synchronous detecting unit 312.

The signal processing unit 100 demodulates a measuring signal by the first angular frequency ωr, and removes the occurred harmonic components using decimation filters to thereby generate demodulated signals having the signal components of the second angular frequency ωd and the cyclic error components of the angular frequencies nωd. The third synchronous detecting unit 310 and the fourth synchronous detecting unit 312 provided in the measuring signal correcting unit 300 further execute demodulation of the demodulated signals using a sine signal and a cosine signal of the angular frequencies nωd. The first filter calculating unit 340 and the second filter calculating unit 350 detects the amplitudes and the initial phases of the cyclic error components to be detected from the demodulated signals as DC signals. Then, the signal generating unit 380 generates removal signals by correcting a phase delay in the removal signals with respect to the cyclic error components due to a processing delay to thereby remove the cyclic error components without causing a delay to the measuring signal.

As described above, a signal to be generated by the signal generating unit 380 corresponds to orders n of cyclic error components included in a measuring signal. For example, a signal to be generated by the signal generating unit 380 may be only a signal for n=½ or may also be a plurality of signals for n=½, 2, 3, and the like. These cyclic error components occur due to reflection, scattering, and incompleteness of light from optical components included in the interferometer 500, and the frequencies of the cyclic error components vary depending on the layouts and characteristics of the optical components. Thus, the signal generating unit 380 may generate a signal in accordance with the design and component characteristics. For example, when a plurality of cyclic error components is removed, a plurality of removal signals is generated by providing a plurality of pairs of the third and fourth synchronous detecting units, a plurality of pairs of the first and second filter calculating units, an amplitude and phase calculating unit, and a signal generating unit. These removal signals are added by the adder-subtractors 302 and 304 so as to remove unnecessary cyclic error components included in the measuring signal.

Here, as an example, assume the case where the processing delay time τ is corrected by giving a delay to a measuring signal when a moving speed v of the target object=1 m/s and a processing delay time τ=10 μs. In this case, a length measurement error of 10 μm occurs in the position calculating unit included in the conventional measuring apparatus. When the processing delay time τ=1 ms, a length measurement error of 1 mm occurs. This length measurement error is unallowable when a position or a displacement of the target object needs to be measured on the precision order of nm to μm. On the other hand, when the moving speed v is calculated by time-differentiating the length measurement value and the length measurement error is corrected by the product of the moving speed v and the processing delay time τ, the noise in the length measurement value increases by time-differentiation, and further increases by the product of the moving speed v and the processing delay time τ. For example, consider the case where two length measurement values with a Ts interval are used for calculating the moving speed v of the target object. At this time, when a length measurement noise Δpos (m) is included in the Ts interval and the noise is a white noise, a noise with a magnitude of (Δpos×√2)/Ts (m/s) is included in the moving speed v to be calculated. Furthermore, a noise with a magnitude of (Δpos×√2×τ)/Ts (m) occurs in a correction value for the length measurement error due to the product of the moving speed v and the processing delay time τ. Thus, when τ=Ts, a noise with √2 times of Δpos occurs. In addition, a noise increases with an increase in the processing delay time τ. In contrast, when the cyclic error components are removed by applying correction of the processing delay time τ to the removal signals as in the present embodiment, the processing delay time τ occurred to a measuring signal becomes minimum by the relationship of τ<<Ts, so that the length measurement error can be reduced. As described above, the signal processing unit 100 detects various cyclic error components from lower to higher orders with respect to the Doppler shift fd to thereby apply correction of a processing delay caused by detection of cyclic error components and generation of removal signals to the removal signals. In this manner, the signal processing unit 100 can remove the cyclic error components with high precision without causing a delay to the measuring signal. Thus, the measuring apparatus of the present embodiment can measure a position or a displacement of a target object with high precision by removing the cyclic error components.

As described above, according to the present embodiment, a measuring apparatus that is advantageous for measuring a position or a displacement of a target object with high precision may be provided.

### Second Embodiment

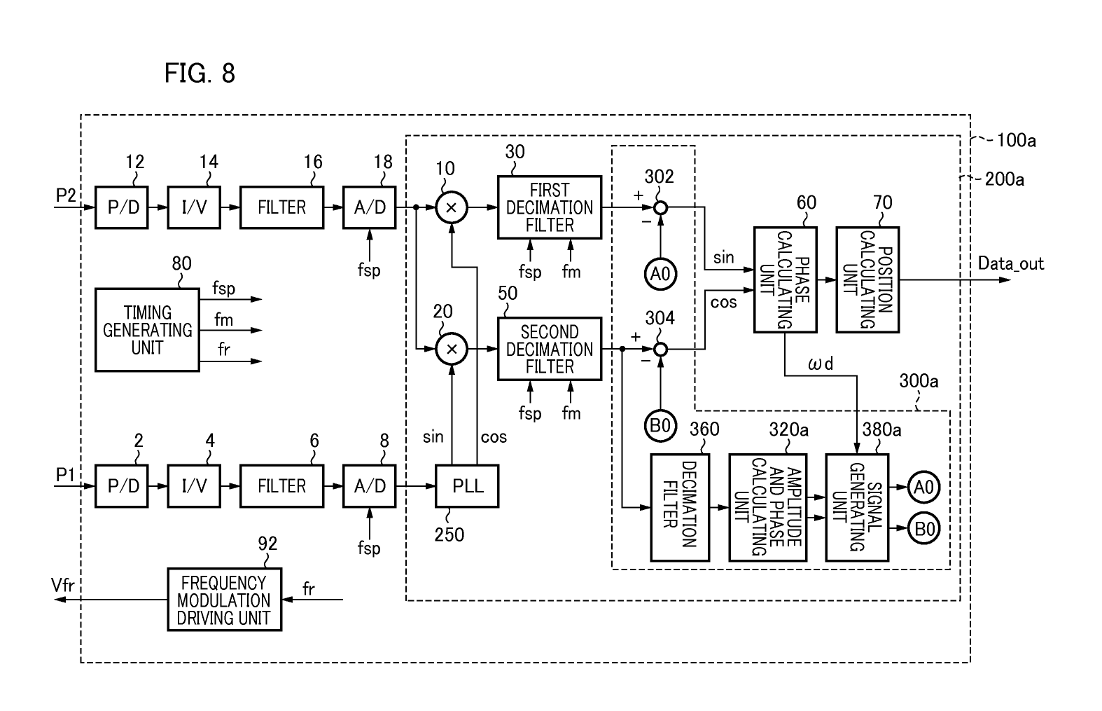

Next, a description will be given of a measuring apparatus according to a second embodiment of the present invention. A feature of the measuring apparatus of the present embodiment lies in the fact that the measuring apparatus has a measuring signal correcting unit 300a instead of the measuring signal correcting unit 300 according to the first embodiment. FIG. 8 is a block diagram illustrating a configuration of the signal processing unit 100a of the present embodiment, which is the one corresponding to the configuration shown in FIG. 2 according to the first embodiment. In FIG. 8, the same elements as those shown in FIG. 2 are designated by the same reference numerals, and thus, explanation thereof will be omitted. As shown in FIG. 8, a measuring signal correcting unit 300a includes a decimation filter 360, an amplitude and phase calculating unit 320a, and a signal generating unit 380a. In order to decrease the calculation load of digital signal processing, the decimation filter 360 performs filtering on the output signal from the second decimation filter 50 at a decimation frequency. The amplitude and phase calculating unit 320a executes Fourier transform calculation to the output signal from the decimation filter 360 to thereby detect the amplitudes Vn and the initial phases en of the cyclic error components of the angular frequencies nωd (n=½, 2, 3, . . . ). In order to decrease the calculation load of digital signal processing, the amplitude and phase calculating unit 320a may execute FFT (Fast Fourier Transform) calculation. The amplitudes Vn and the initial phases θn of the cyclic error components detected by the amplitude and phase calculating unit 320a are input to the signal generating unit 380a as the amplitudes AMP and the phases OFS of the cyclic error components.

Here, as described in the first embodiment, a phase delay occurs in the removal signals with respect to the cyclic error components due to a processing delay caused by detection of the cyclic error components and generation of the removal signals, and thus, it is difficult to remove the cyclic error components with high precision. Thus, in the present embodiment, the signal generating unit 380a corrects a phase delay as follows.

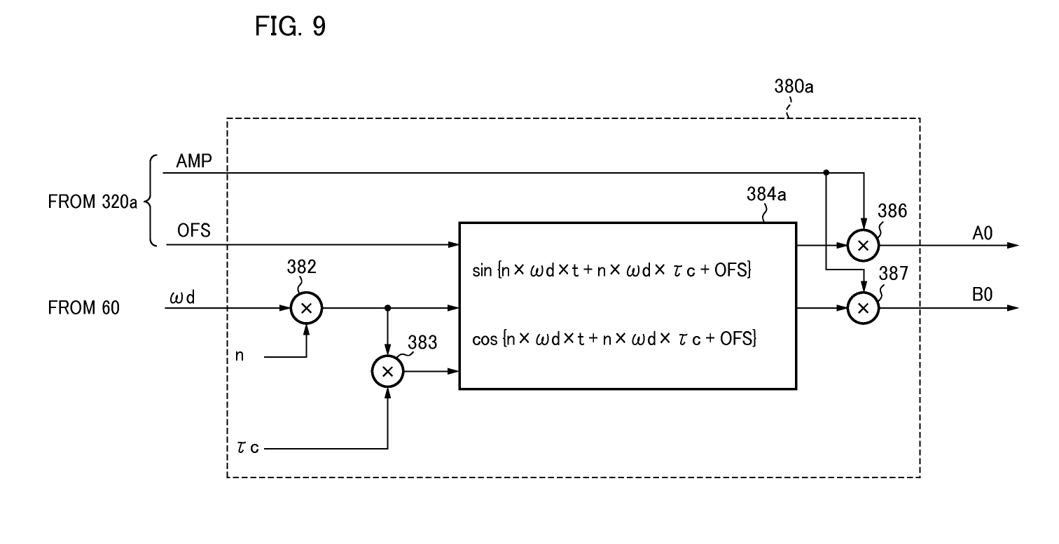

FIG. 9 is a block diagram illustrating a configuration of the signal generating unit 380a. Hereinafter, a description will be given of a phase delay correcting method and a signal generating method performed by the signal generating unit 380a with reference to FIG. 9. Firstly, the amplitude and phase calculating unit 320a inputs the amplitudes AMP and the phases OFS of the cyclic error components to the signal generating unit 380a. Furthermore, the phase calculating unit 60 (or the position calculating unit 70) inputs the second angular frequency ωd to the signal generating unit 380a. The multiplier 382 multiplies the second angular frequency ωd by orders n of cyclic error components, and the multiplication result nωd is input to the multiplier 383 and a sine/cosine generating unit 384a. The multiplication result nωd input to the multiplier 383 is multiplied by the correction value τc for the processing delay time τ, and the multiplication result (nωd×τc) is input to the sine/cosine generating unit 384a. The phase delay (nωd×t) is corrected as a result of calculation. The sine/cosine generating unit 384a executes calculation of equation (30) based on the input signals from the amplitude and phase calculating unit 320a and the multipliers 382 and 383 to thereby output a sine signal and a cosine signal by using the value as a phase.

The multipliers 386 and 387 multiply the obtained sine and cosine signals by the amplitude AMP to thereby generate the removal signals A0 and B0. Here, a processing delay time τ2 occurs due to the above calculation. Thus, when phase delay correction is performed by setting the correction value τc as equation (31), the first removal signal A0 and the second removal signal B0 are represented by equations (32) and (33) based on the calculation result of the relationship in equation (29). Thus, as in the description in the first embodiment, a phase delay (nωd×τ) of the first removal signal A0 and the second removal, signal B0, which are the output signals from the signal generating unit 380a, is corrected with respect to the cyclic error components, so that the amplitudes and the phases of the first removal signal A0 and the second removal signal B0 are matched to those of the cyclic error components. In other words, it can be seen that the cyclic error components C1 and C2 represented by equations (27) and (28) can be removed with high precision.

In the present embodiment, in particular, since Fourier transform calculation is executed by the amplitude and phase calculating unit 320a, the third synchronous detecting unit 310 and the fourth synchronous detecting unit 312 according to the first embodiment are not provided in the measuring signal correcting unit 300a. Thus, as can be seen from the block diagram shown in FIG. 9, the sine/cosine generating unit 384a does not need to generate a sine signal and a cosine signal for synchronous detection. As described above, according to the measuring apparatus of the present embodiment, the same effect as that of the measuring apparatus of the first embodiment is provided while simplifying the configuration of the measuring signal correcting unit 3003.

### Third Embodiment

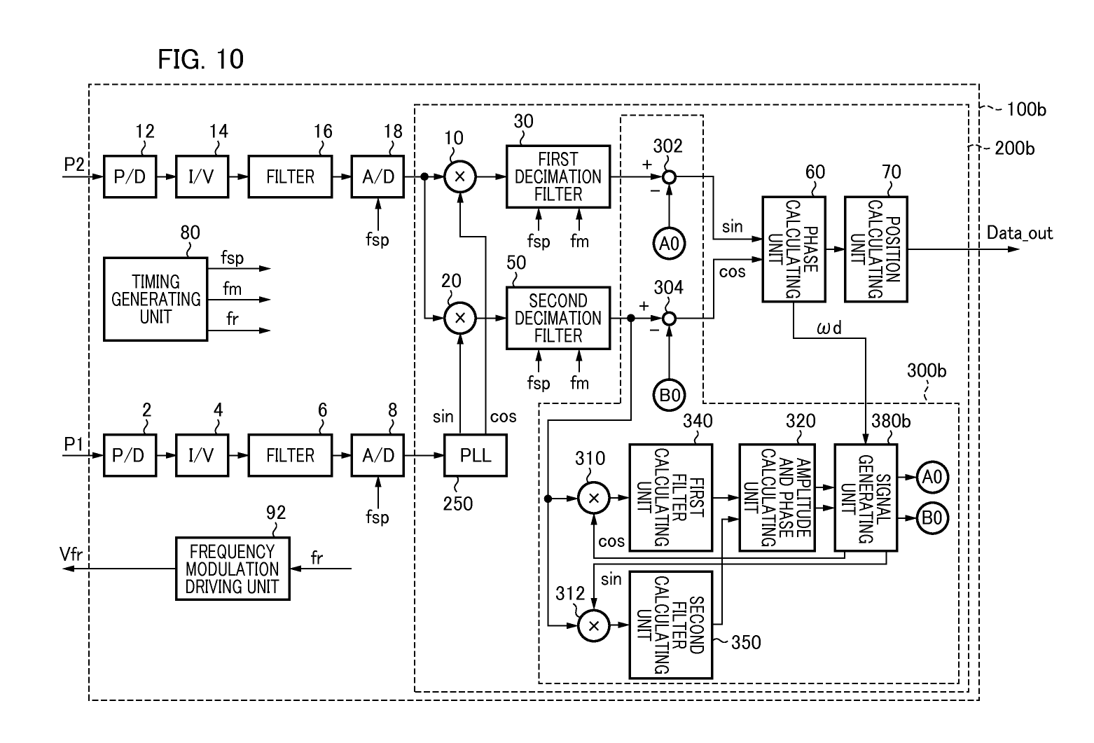

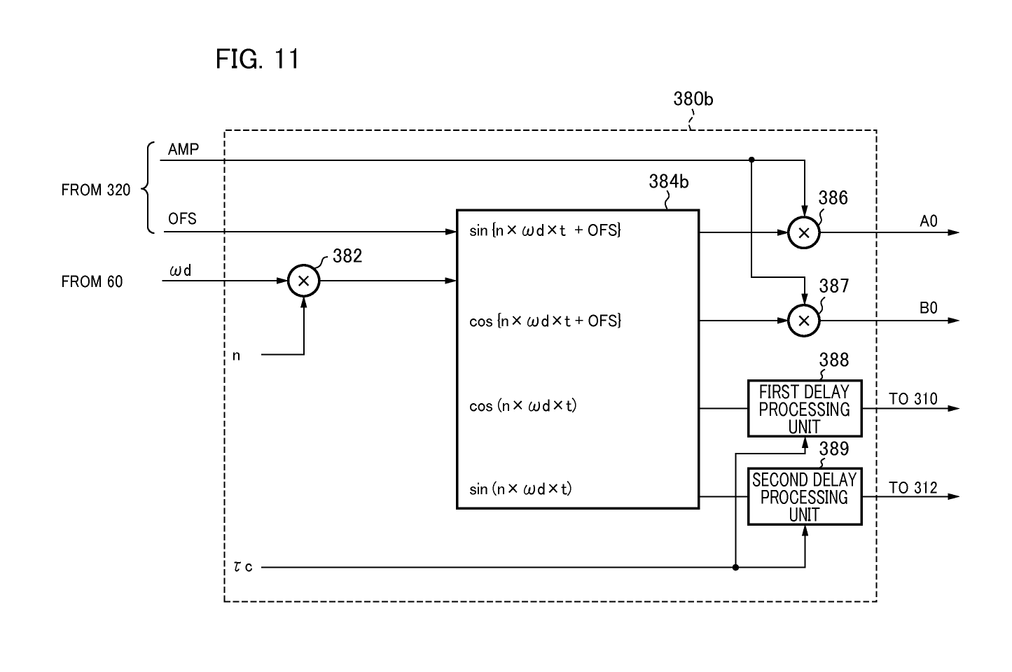

Next, a description will be given of a measuring apparatus according to a third embodiment of the present invention. A feature of the measuring apparatus of the present embodiment lies in the fact that the measuring apparatus further has a signal, generating unit 380b instead of the signal generating unit 380 included in the measuring signal correcting unit 300 according to first embodiment. FIG. 10 is a block diagram illustrating a configuration of the signal processing unit 100b including the signal generating unit 380b, which is the one corresponding to the configuration shown in FIG. 2 according to the first embodiment. In FIG. 10, the same elements as those shown in FIG. 2 are designated by the same reference numerals, and thus, explanation thereof will be omitted. FIG. 11 is a block diagram illustrating a configuration of the signal generating unit 380b. In the present embodiment, in particular, the signal generating unit 380b includes a first delay processing unit 388 and a second delay processing unit 389.

Firstly, a description will be given of a phase delay correcting method and a signal generating method performed by the signal generating unit 380b with reference to FIG. 11. The phase calculating unit 60 (or the position calculating unit 70) inputs the second angular frequency ωd to the signal generating unit 380b. The multiplier 382 multiplies the second angular frequency ωd by orders n of cyclic error components, and the multiplication result nωd is input to the sine/cosine generating unit 384b. The sine/cosine generating unit 384b generates a sine signal and a cosine signal based on the value. Here, for example, previously obtained sine and cosine values are stored in a memory as a table, so that a sine signal and a cosine signal may be generated with reference to the table in accordance with the values of (nωd×t). Then, the first delay processing unit 388 and the second delay processing unit 389 perform delay processing based on the correction value τc for the processing delay time τ by using the acquired sine and cosine signals. Here, the sine and cosine signals are delayed by the correction value τc so that a phase delay of (nωd×τc) occurs in the sine and cosine signals. In other words, the output signals from the first delay processing unit 388 and the second delay processing unit 389 are represented by equations (34) and (35), respectively:

(Output from first delay processing unit 388)=cos(nωd×t−nωd×τc) (34)

(Output from second delay processing unit 389)=sin(nωd×t−nωd×τc) (35)

On the other hand, the amplitude and phase calculating unit 320 inputs the amplitudes AMP and the phases OFS of the cyclic error components to the signal generating unit 380b. The sine/cosine generating unit 384b outputs a sine signal and a cosine signal based on the input signals from the amplitude and phase calculating unit 320 and the multiplier 382.

Here, a description will be given of a method for calculating the amplitudes AMP and the phases OFS of the cyclic error components to be input to the signal generating unit 380b with reference to FIG. 10. The output signals from the first delay processing unit 388 and the second delay processing unit 389 are used for demodulating the output signal from the second decimation filter 50 in the third synchronous detecting unit 310 and the fourth synchronous detecting unit 312. The demodulated signals from the third synchronous detecting unit 310 and the fourth synchronous detecting unit 312 are represented by equations (36) and (37):

$$\begin{matrix}( Output from third synchronous detecting unit 31 \; 0 ) = Vn \times cos ( n ω d \times t + θ n ) \times cos ( n ω d \times t - n ω d \times τ c ) = Vn / 2 \times \{ cos ( n ω d \times τ c + θ n ) + cos ( 2 \times n ω d \times t - n ω d \times τ c + θ n ) \} & ( 36 ) \\ ( Output from fourth synchronous detecting unit 31 \; 2 ) = Vn \times cos ( n ω d \times t + θ n ) \times sin ( n ω d \times t - n ω d \times τ c ) = Vn / 2 \times \{ - sin ( n ω d \times τ c + θ n ) + sin ( 2 \times n ω d \times t - n ω d \times τ c + θ n ) \} & ( 37 )\end{matrix}$$

At this time, as in the first embodiment, the components of the angular frequency ωd±nωd are removed by the first filter calculating unit 340 and the second filter calculating unit 350, and thus, are not included in equations (36) and (37). Furthermore, the demodulated signals represented by equations (36) and (37) are respectively input to the first filter calculating unit 340 and the second filter calculating unit 350, and the harmonic components of the second terms on the right sides of equations (36) and (37) are also removed. Thus, the output signals from the first filter calculating unit 340 and the second filter calculating unit 350 are finally represented by equations (38) and (39), respectively:

(Output from first filter calculating unit 340)=Vn/2×cos(nωd×τc+θn) (38)

(Output from second filter calculating unit 350)=−Vn/2×sin(nωd×τc+θn) (39)

The output signals from the first filter calculating unit 340 and the second filter calculating unit 350 represented by equations (38) and (39) are input to the amplitude and phase calculating unit 320. The amplitude and phase calculating unit 320 executes calculation of equations (40) and (41) to thereby output amplitudes AMP and phases OFS.

(Amplitude AMP)=√[{Vn/2×cos(nωd×τc+θn)}²+{−Vn/2×sin(nωd×c+θn)}²]×2=Vn (40)

(Phase OFS)=atan [{−Vn/2×sin(nωd×τc+θn)}/{Vn/2×cos(nωd×τc+θn)}]×(−1)=atan {sin(nωd×τc+θn)/cos(nωd×τc+θn)}=nωd×τc+θn (41)

With the above calculation, the amplitudes Vn of the cyclic error components of the angular frequencies nωd included in the measuring signal and the phases represented by equation (41), in which the phase of which leads that of the initial phase θn by (nωd×τc), can be calculated. Thus-obtained amplitudes Vn and the phases in equation (41) are input to the signal generating unit 380b as the amplitudes AMP and the phases OFS of the cyclic error components.

Referring back to FIG. 11, the sine/cosine generating unit 384b executes calculation of equation (42) based on the input signals from the amplitude and phase calculating unit 320 and the multiplier 382 to thereby output a sine signal and a cosine signal by using the value as a phase.

$$\begin{matrix}( Phase ) = n ω d \times t + OFS \\ = n ω d \times t + n ω d \times τ c + θ n\end{matrix} \qquad ( 42 )$$

In the present embodiment, phase delay correction has already been performed for the values of the phases OFS in contrast to the first and second embodiments, and thus, the sine/cosine generating unit 384b does not perform phase delay correction processing.

The multipliers 386 and 387 multiply the obtained sine and cosine signals by the amplitude AMP to thereby generate the removal signals A0 and B0. Here, a processing delay time τ2 occurs due to the above calculation. Thus, when phase delay correction is performed by setting the correction value τc as equation (31), the first removal signal A0 and the second removal signal B0 are represented by equations (32) and (33) based on the calculation result of the relationship in equation (29). Thus, as in the description in the first embodiment, a phase delay (nωd×τ) of the first removal signal A0 and the second removal, signal B0, which are the output signals from the signal generating unit 380b, is corrected with respect to the cyclic error components, so that the amplitudes and the phases of the first removal signal A0 and the second removal signal B0 are matched to those of the cyclic error components. In other words, it can be seen that the cyclic error components C1 and C2 represented by equations (27) and (28) can be removed with high precision. As described above, according to the measuring apparatus of the present embodiment, the same effect as that of the measuring apparatus of the first embodiment is provided.

### Fourth Embodiment

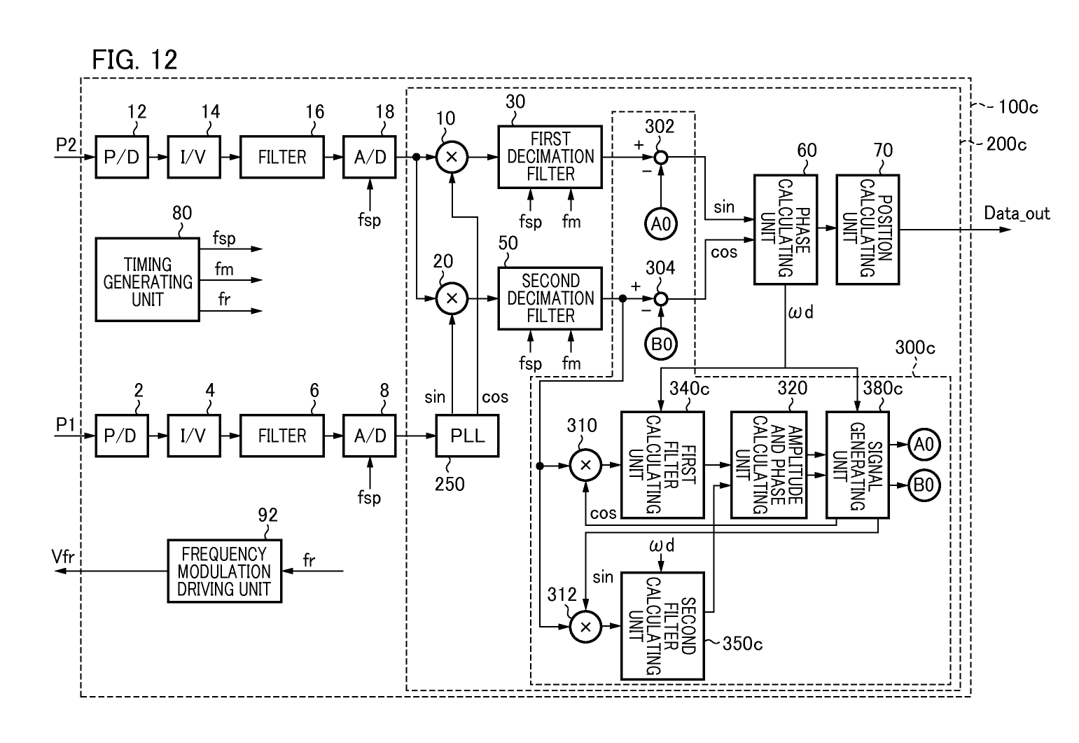

Next, a description will be given of a measuring apparatus according to a fourth embodiment of the present invention. A feature of the measuring apparatus of the present embodiment lies in the fact that the measuring apparatus has a first filter calculating unit 340c and a second filter calculating unit 350c instead of the first filter calculating unit 340 and the second filter calculating unit 350 according to the first embodiment and a signal generating unit 380c instead of the signal generating unit 380 according to the first embodiment. FIG. 12 is a block diagram illustrating a configuration of the signal processing unit 100c according to the present embodiment, which is the one corresponding to the configuration shown in FIG. 2 according to the first embodiment. In FIG. 12, the same elements as those shown in FIG. 2 are designated by the same reference numerals, and thus, explanation thereof will be omitted.

As described above, the amplitudes Vn and the initial phases θn of the cyclic error components are included in the DC components of the output signals from the third synchronous detecting unit 310 and the fourth synchronous detecting unit 312 represented by equations (19) and (20). Thus, the first filter calculating unit 340c and the second filter calculating unit 350c remove unnecessary frequency components other than DC components. Since the values of the unnecessary frequency components varies depending on the value of the second angular frequency ωd, the required characteristic of the filter also varies in association with a variation of the values. Thus, upon designing a filter, the range of the second angular frequency ωd for detecting the amplitude Vn and the initial phase θn needs to be defined in advance and the second angular frequency ωd needs to be set to a lower limit value of the range. Here, consider the case where the second angular frequency ωd is lower than the defined lower limit value. The values of the amplitude Vn and the initial phase θn detected when the second angular frequency ωd falls within the defined range may be used. If the values of the amplitude Vn and the initial phase θn change at this time, a detection error may occur. Thus, it is preferable that the lower limit value of the second angular frequency ωd is as low as possible. However, since the detection rate between the amplitude Vn and the initial phase θn varies depending on the characteristic of a filter, a filter usable for a lower second angular frequency ωd has a low detection rate. In other words, a decrease in the lower limit value of the second angular frequency ωd and an increase in the detection rate are in trade-off relationship, and thus, it is difficult to design a filter that simultaneously satisfies two requests. Thus, the characteristic of a filter is changed in accordance with the value of the second angular frequency ωd in order to cope with the trade-off relationship between a decrease in the lower limit value of the second angular frequency ωd and an increase in the detection rate between the amplitude Vn and the initial phase θn as much as possible. In particular, in the present embodiment, the first filter calculating unit 340c and the second filter calculating unit 350c performs filter switching in accordance with the value of the second angular frequency ωd input from the phase calculating unit 60 (or the position calculating unit 70).

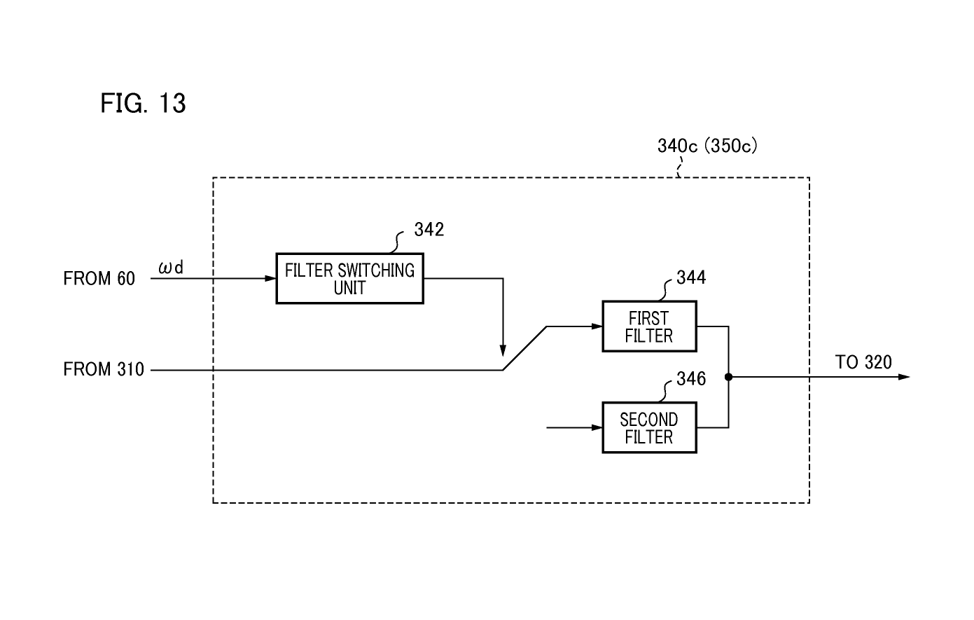

FIG. 13 is a block diagram illustrating a configuration of the first filter calculating unit 340c. The configuration of the second filter calculating unit 350c is the same as that of the first filter calculating unit 340c. The first filter calculating unit 340c includes a filter switching unit 342 and a plurality of filters (a first filter 344 and a second filter 346), which are switched by the filter switching unit 342, having different characteristics. The filter switching unit 342 performs switching between the first filter 344 and the second filter 346 based on the second angular frequency ωd input from the phase calculating unit 60 and a preset threshold value ωth. Either one of the selected first filter 344 or second filter 346 removes unnecessary frequency components other than DC components included in the output signal from the third synchronous detecting unit 310. Note that the first filter 344 and the second filter 346 may be LPFs (Low Pass Filters) or may also be decimation filters using CIC filters or the like.

Furthermore, since the detection rate between the amplitude Vn and the initial phase 8n varies in accordance with the characteristic of the selected filter as described above, a processing delay time τ1 occurred when the cyclic error components are detected and a signal phase-locked to the cyclic error components is generated varies depending on the filter type. Thus, in association with filter switching in the first filter calculating unit 340c, the signal generating unit 380c also performs switching of the correction value τc for the processing delay time τ.

For example, consider the case where the amplitudes Vn and the initial phases θn of cyclic error components are detected when a light source of λ=1.55 μm is used, j=4, fr=20 MHz, and fd=500 Hz to 5 MHz, that is, a moving speed v of the target object=0.194 mm/s to 1.94 m/s. Assume that the sampling frequency fsp=100 MHz, and a decimation frequency fm=50 MHz by the second decimation filter 50 after demodulation by the first angular frequency ωr. For example, when n=½, the output signal from the second decimation filter 50 consists of the signal component of the second angular frequency ωd and the cyclic error component of the angular frequency (½)ωd. At this time, upon demodulation by the angular frequency (½) ωd in the third synchronous detecting unit 310, the frequency components which appear in the output signal from the synchronous detecting unit are direct current, (½) ωd, ωd, and (3/2) ωd. Since the amplitudes Vn and the initial phases en of the cyclic error components to be detected are included in the DC components, the first filter calculating unit 340c removes unnecessary frequency components (½)ωd, ωd, and (3/2) ωd.

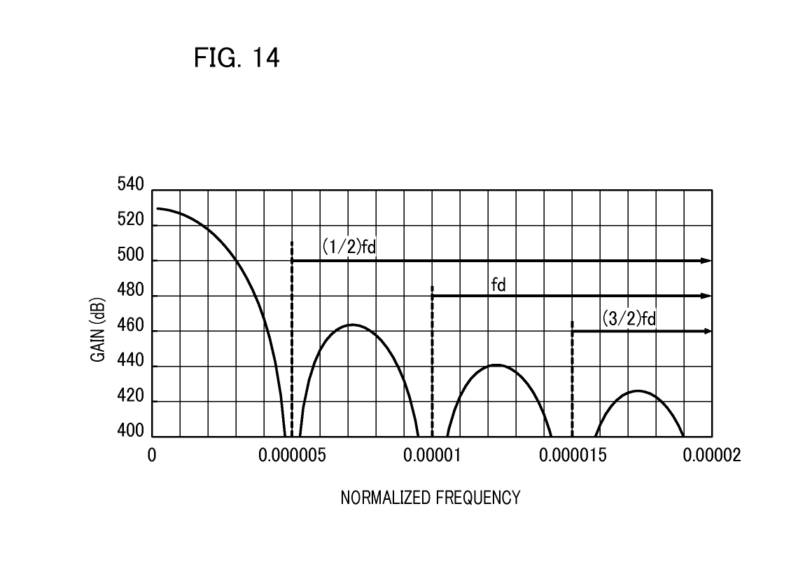

Here, assume the case where the CIC filter exemplified in FIG. 6 in the first embodiment is used for the first filter 344 in the present embodiment as a first CIC filter. When the first CIC filter is used in the case where the second angular frequency ωd is 20 kHz or greater, unnecessary angular frequency components (½) ωd (10 kHz or greater), ωd (20 kHz or greater), and (3/2)ωd (30 kHz or greater) with respect to direct current can obtain a sufficient removal rate of 60 dB or greater. Note that the detection rate between the amplitude Vn and the initial phase en corresponds to the decimation frequency fm1 by the first CIC filter, and thus, is 20 kHz. On the other hand, assume that a second CIC filter having the characteristic as shown in FIG. 14 corresponding to FIG. 6 is used as the second filter 346 in the present embodiment. Note that the second CIC filter is configured by setting D=2, m=100000, and N=5. Since the second CIC filter is configured by setting m=100000, the decimation frequency fm2 is 500 Hz. Thus, the signal frequency which undergoes digital signal processing is ½ of the decimation frequency fm2, that is, 250 Hz. Under this condition, a notch characteristic in which the gain abruptly attenuates appears at the normalized frequency=0.000005, that is, 250 Hz as shown in FIG. 14. Thus, when the second CIC filter is used in the case where the second angular frequency ωd is 500 Hz or greater, unnecessary angular frequency components (½)ωd (250 Hz or greater), (d (500 Hz or greater), and (3/2)ωd (750 Hz or greater) with respect to direct current can obtain a removal rate of 60 dB or greater. Note that the detection rate between the amplitude Vn and the initial phase θn corresponds to the decimation frequency fm2 by the second CIC filter, and thus, is 500 Hz. As described above, with the use of the first and second CIC filters as the first filter 344 and the second filter 346, a high detection rate (20 kHz) can be realized when fd=20 kHz or greater and unnecessary angular frequency components can be removed when fd is in the range of from 500 Hz to 5 MHz.

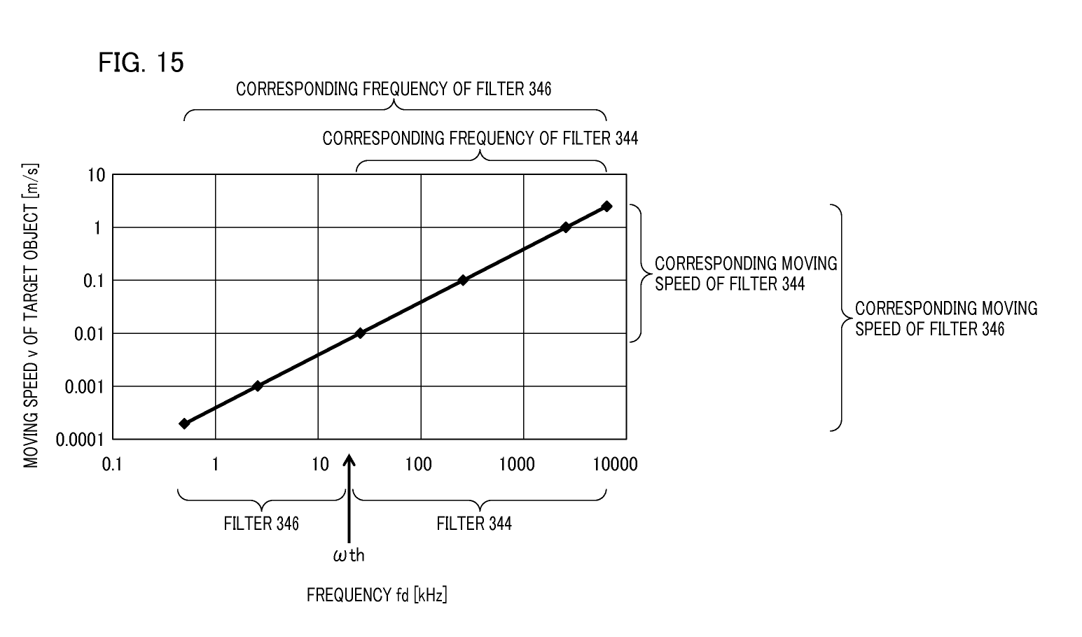

Next, a description will be given of the relationship between corresponding frequencies and corresponding moving speeds of the first filter 344 and the second filter 346 at this time and filter switching between the first filter 344 and the second filter 346. FIG. 15 is a graph illustrating the relationship, where the second frequency fd (kHz) is plotted on the horizontal axis and a moving speed v (m/s) of the target object at this time is plotted on the vertical axis. The corresponding frequency of the first filter 344 is in the relationship of fd 20 kHz, and the corresponding moving speed of the first filter 344 is in the relationship of v≧7.75 mm/s. On the other hand, the corresponding frequency of the second filter 346 is in the relationship of fd≧500 Hz, and the corresponding moving speed of the second filter 346 is in the relationship of v≧0.194 mm/s. In this example, the threshold value ωth for the filter switching unit 342 is set to 20 kHz and switching is performed between the first filter 344 and the second filter 346. As described above, the corresponding range can be expanded to a moving speed which cannot be handled by the first filter 344 by switching the first filter 344 and the second filter 346 as appropriate. Consequently, even when the target object moves at various speeds, the amplitude Vn and the initial phase θn can be detected. Since the detection rate between the amplitude Vn and the initial phase θn varies in accordance with the characteristics of the first and second CIC filters, the threshold value ωth for the filter switching unit 342 may be set to match the requested detection rate. Each of the first filter calculating unit 340c and the second filter calculating unit 350c may be configured by k (integer greater than 2) number of filters and (k−1) number of threshold values ωth. Furthermore, as shown in the second embodiment, the measuring signal correcting unit 300c may be configured by the decimation filter 360, the amplitude and phase calculating unit 320a, and the signal generating unit 380a so as to detect the amplitudes Vn and the initial phases en of the cyclic error components by Fourier transform calculation. In this case, the decimation filter 360 performs filter switching. As described above, according to the measuring apparatus of the present embodiment, the same effect as that of the measuring apparatus of the first embodiment is provided. In particular, the measuring apparatus of the present embodiment is advantageous for suppressing limitations by the moving speed of the target object as much as possible.

### Fifth Embodiment

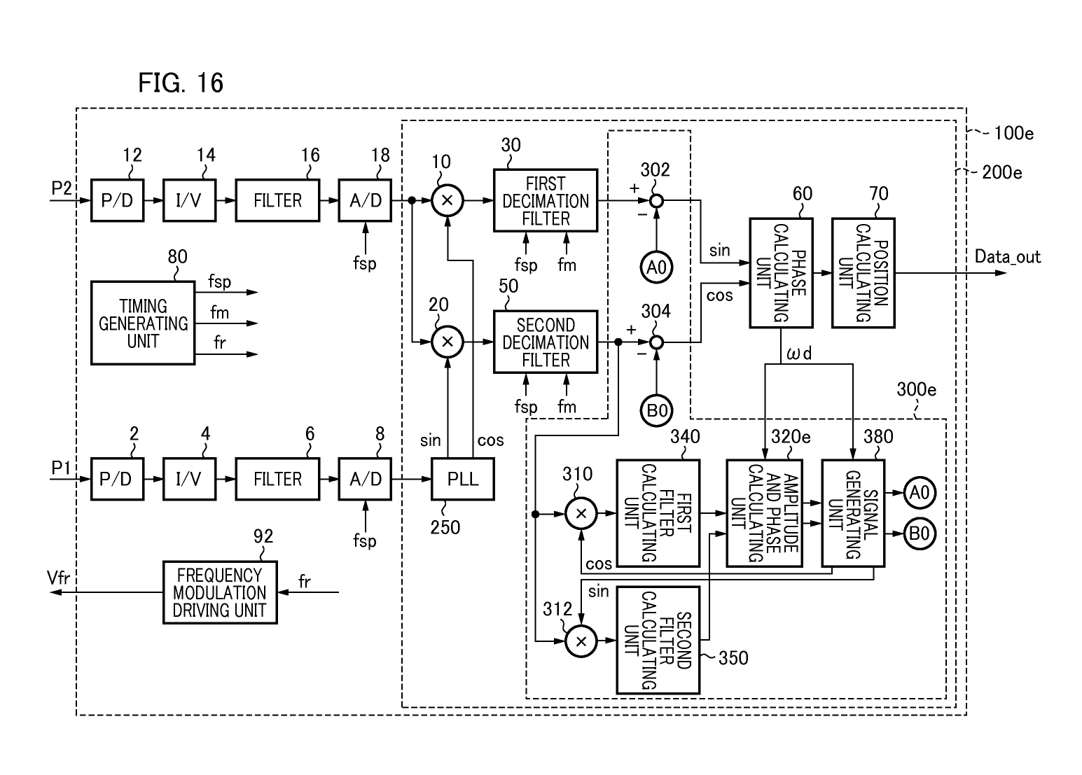

Next, a description will be given of a measuring apparatus according to a fifth embodiment of the present invention. A feature of the measuring apparatus of the present embodiment lies in the fact that the measuring apparatus has an amplitude and phase calculating unit 320e instead of the amplitude and phase calculating unit 320 included in the measuring signal correcting unit 300 according to the first embodiment. FIG. 16 is a block diagram illustrating a configuration of the signal processing unit 100e according to the present embodiment, which is the one corresponding to the configuration shown in FIG. 2 according to the first embodiment. In FIG. 16, the same elements as those shown in FIG. 2 are designated by the same reference numerals, and thus, explanation thereof will be omitted.

Consider the case where the motion of the target object is accelerated. In this case, an error with respect to the true value for the second angular frequency ωd occurs in the calculated value of the second angular frequency ωd, which is output from the phase calculating unit 60 (or the position calculating unit 70), correlating the acceleration of the target object due to a processing delay caused by digital signal processing. Then, the second angular frequency ωd containing an error therein is input to the signal, generating unit 380 and then is used for generating a sine signal and a cosine signal for demodulating the output signal from the second decimation filter 50 and for generating the removal signals A0 and B0.

Firstly, when a sine signal and a cosine signal are generated by using the second angular frequency ωd containing an error therein, the demodulated signals in equations (43) and (44) are output from the third synchronous detecting unit 310 and the fourth synchronous detecting unit 312. Note that “ωd” represents a true value for the second angular frequency, whereas “ωd′” represents a calculated value by the phase calculating unit 60:

$$\begin{matrix}( Output from third synchronous detecting unit 31 \; 0 ) = Vn \times cos ( n \times ω d \times t + θ n ) \times cos ( n \times ω {d}^{′} \times t ) = Vn / 2 \times [ cos \{ n ( ω d - ω {d}^{′} ) \times t + θ n \} + cos \{ n ( ω d + ω {d}^{′} ) \times t + θ n \} ] & ( 43 ) \\ ( Output from fourth synchronous detecting unit 31 \; 2 ) = Vn \times cos ( n \times ω d \times t + θ n ) \times sin ( n \times ω {d}^{′} \times t ) = Vn / 2 \times [ - sin \{ n ( ω d - ω {d}^{′} ) \times t + θ n \} + sin \{ n ( ω d + ω {d}^{′} ) \times t + θ n \} ] & ( 44 )\end{matrix}$$

The demodulated signals represented by equations (43) and (44) are respectively input to the first filter calculating unit 340 and the second filter calculating unit 350, and the harmonic components of the second terms on the right sides of equations (43) and (44) are also removed. Thus, the output signals from the first filter calculating unit 340 and the second filter calculating unit 350 are finally represented by equations (45) and (46), respectively:

(Output from first filter calculating unit 340)=Vn/2×cos {n(ωd−ωd′)×t+θn} (45)

(Output from second filter calculating unit 350)=−Vn/2×sin {n(ωd−ωd′)×t+θn} (46)

Note that, since the output signals in equations (45) and (46) are a cosine signal and a sine signal having angular frequencies n(ωd−ωd′), the values change depending on the difference n(ωd−ωd′) between the true value nωd and the calculated value nωd′ for the angular frequency and the time t.

The output signals from the first filter calculating unit 340 and the second filter calculating unit 350 represented by equations (45) and (46) are input to the amplitude and phase calculating unit 320e. The amplitude and phase calculating unit 320e executes calculation of equations (47) and (48) to thereby output amplitudes AMP and phases OFS.

(Amplitude AMP)=√[[Vn/2×cos {n(ωd−ωd′)×t+θn}]²+[−Vn/2×sin {n(ωd−ωd′)×t+θn}]²]×2=Vn (47)

(Phase OFS)=atan [[−Vn/2×sin {n(ωd−ωd′)×t+θn}]/[Vn/2×cos {n(ωd−ωd′)×t+θn}]]×(−1)=atan [sin {n(ωd−ωd′)×t+θn}/cos {n(ωd−ωd′)×t+θn}]=n(ωd−ωd′)×t+θn (48)

Here, the amplitudes Vn of the cyclic error components can be calculated according to the calculation in equation (47). However, when the motion of the target object is accelerated, the true value nωd and the calculated value nωd′ for the angular frequencies of the cyclic error components are different from each other. Thus, the initial phases θn of the cyclic error components cannot be calculated according to the calculation in equation (48). Furthermore, when an attempt is made to determine the initial phases θn based on equation (48), a detection error θerr represented by equation (49), which is defined by the difference n(ωd−ωd′) between angular frequencies and the time t, occurs:

θerr=nωd×t−nωd′×t (49)

The occurrence of the detection error θerr makes it difficult to remove the cyclic error components with high precision by the adder-subtractors 302 and 304. Thus, in the present embodiment, the amplitude and phase calculating unit 320e determines the values of the phases OFS to be output while taking acceleration into consideration as follows.

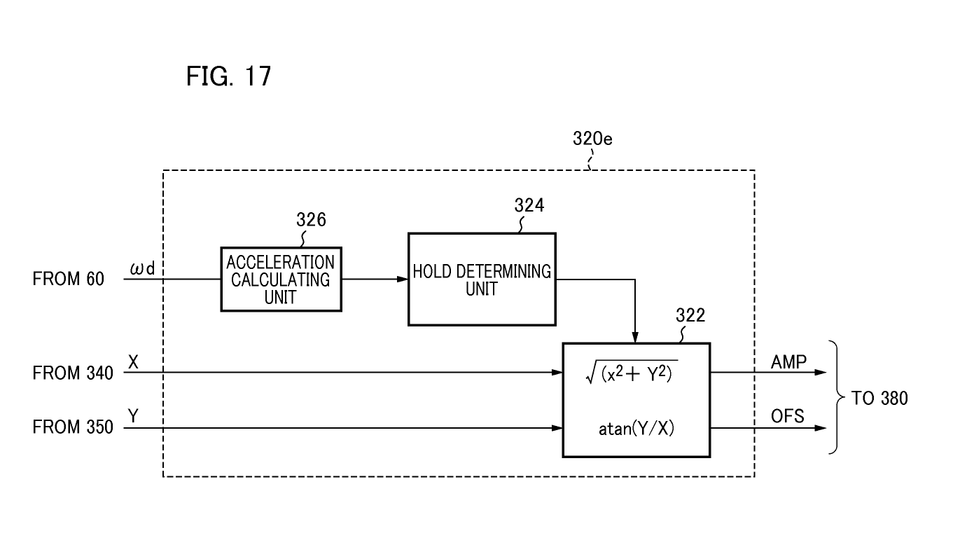

FIG. 17 is a block diagram illustrating a configuration of the amplitude and phase calculating unit 320e. The amplitude and phase calculating unit 320e includes an acceleration calculating unit 326, a hold determining unit 324, and an amplitude and phase calculator 322. Firstly, the acceleration calculating unit 326 executes calculation such as differentiation to the second angular frequency ωd input from the phase calculating unit 60 to thereby calculate acceleration. The hold determining unit 324 performs hold determination of the output signal from the amplitude and phase calculator 322 based on the output signal from the acceleration calculating unit 326 and a threshold value for the preset acceleration to thereby output a control signal which may have two states, i.e., “update” and “hold” to the amplitude and phase calculator 322. Next, the amplitude and phase calculator 322 updates or holds the amplitude AMP and the phase OFS based on the control signal from the hold determining unit 324 to thereby output the amplitude AMP and the phase OFS. For example, when the hold determining unit 324 outputs a control signal in the “update” state, the amplitude and phase calculator 322 calculates and outputs the amplitude AMP and the phase OFS using the input values X and Y from the first filter calculating unit 340 and the second filter calculating unit 350. On the other hand, when the hold determining unit 324 outputs a control signal in the “hold” state, the amplitude and phase calculator 322 holds and outputs the last-updated values of the amplitude AMP and the phases OFS regardless of the input values X and Y from the first filter calculating unit 340 and the second filter calculating unit 350.

Note that the acceleration threshold value for switching two states (update and hold) of a control signal output from the hold determining unit 324 may be selected for the requested length-measuring precision. Among the amplitude AMP and the phase OFS which are the output signals from the amplitude and phase calculator 322, the amplitude and phase calculator 322 may also hold the phase OFS only. As shown in the second embodiment, a measuring signal correcting unit may also be configured by the decimation filter 360, the amplitude and phase calculating unit 320a, and the signal generating unit 380a so as to detect the amplitudes Vn and the initial phases θn of the cyclic error components by Fourier transform calculation. In this case, when the motion of the target object is accelerated, the amplitude and phase calculating unit 320a holds the values of the amplitude Vn and the initial phase θn. Furthermore, as shown in the third embodiment, a measuring signal correcting unit may also be configured by using the signal generating unit 380b instead of the signal generating unit 380 so as to correct a phase delay occurred in a removal signal. In this case, when the motion of the target object is accelerated, the amplitude and phase calculating unit 320e holds the values of the amplitude AMP and the phase OFS.

Furthermore, when the motion of the target object is accelerated and the first removal signal A0 and the second removal signal B0 are generated by using the calculated value of the second angular frequency ωd output from the phase calculating unit 60, the angular frequencies of the first removal signal A0 and the second removal signal B0 are different from those of the cyclic error components. For example, consider the case where the amplitudes Vn and the initial phases θn of cyclic error components are detected when a light source of λ=1.55 μm is used, j=4, and fr=20 MHz. Assume that the sampling frequency fsp=100 MHz, and a decimation frequency fm=50 MHz by the second decimation filter 50 after demodulation by the first angular frequency ωr. Furthermore, assume that an error included in the calculated value of the second angular frequency ωd is caused by a processing delay of 1 μs, and the hold determining unit 324 holds the values of the amplitude AMP and the phase OFS of a cyclic error so that the values are precisely detected even when the motion of the target object is accelerated. In this case, an error included in the calculated value of the second angular frequency ωd varies depending on the magnitude of the acceleration of the target object. For example, when the acceleration is 20 G (196 m/s²), the error is 506 Hz. Furthermore, the error leads to a phase difference between a cyclic error component and a removal signal, and the magnitude of the phase difference is 0.325 (rad). Thus, a length measurement error occurs due to a phase difference and the magnitude of the phase difference varies depending on the voltage ratio of the signal component of the second angular frequency ωd to be detected to an unnecessary cyclic error component to be detected. When the voltage of the cyclic error component is 1% of that of the signal component, the length measurement error is 0.199 nm, whereas when the voltage of the cyclic error component is 2% of that of the signal component, the length measurement error is 0.398 μm. When the length measurement errors are normalized by 1.23 nm (voltage ratio: 1%) and 2.47 nm (voltage ratio: 2%) that are the maximum values of the length measurement errors caused by the phase differences between the cyclic error components and the removal signals, both normalized length measurement errors become 0.162.

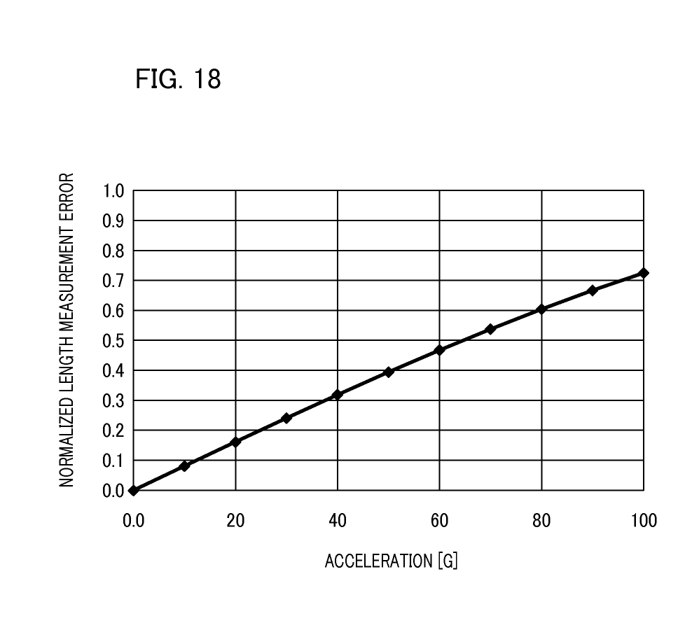

FIG. 18 is a graph illustrating the characteristic of normalized length measurement error with respect to acceleration. In FIG. 18, the acceleration is plotted on the horizontal axis and the normalized length measurement error is plotted on the vertical axis. As shown in FIG. 18, when the acceleration is low, it can be seen that a length measurement error can be significantly reduced by holding the values of the amplitude AMP and the phases OFS. When the calculated value of the second angular frequency ωd output from the phase calculating unit 60 is corrected by acceleration, an error included in the calculated value of the second angular frequency ωd can be reduced, so that the cyclic error components can further be removed with high precision. As described above, according to the measuring apparatus of the present embodiment, a position or a displacement of a target object can further be measured with high precision.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-036398 filed on Feb. 26, 2013, which is hereby incorporated by reference herein in its entirety.

What is claimed is:

1. A measuring apparatus that acquires a reference signal from a reference beam modulated by a first frequency, acquires a measuring signal from a measuring beam further modulated by a second frequency which occurs due to movement of a target object in addition to modulation by the first frequency, and measures a position or a displacement of the target object by calculating a phase difference between the reference signal and the measuring signal, the measuring apparatus comprising:
a demodulation unit configured to demodulate the measuring signal by the first frequency to thereby generate a demodulated signal including the component of the second frequency, a cyclic error component depending on the second frequency, and a harmonic component occurred due to demodulation;
a decimation filter configured to remove the harmonic component from the demodulated signal to thereby output a signal including the component of the second frequency and the cyclic error component;
a measuring signal correcting unit configured to detect and remove the cyclic error component included in the output signal from the decimation filter;
a phase calculating unit configured to calculate the phase difference between the reference signal and the measuring signal based on the output signal from the measuring signal correcting unit; and
a position calculating unit configured to calculate the position or the displacement of the target object based on the output signal from the phase calculating unit,
wherein the measuring signal correcting unit further comprises:
a detector configured to detect the cyclic error component;
a signal generating unit configured to generate a removal signal for removing the cyclic error component;
a removing unit configured to remove the cyclic error component using the removal signal to thereby output the component of the second frequency; and
a processing delay correcting unit configured to correct a processing delay of the detector and the signal generating unit.

2. The measuring apparatus according to claim 1, wherein, given that the second frequency is fd, the frequency of the cyclic error component is represented by the product of n and fd (provided that n=½, 2, 3, . . . ).

3. The measuring apparatus according to claim 1, wherein the demodulation unit demodulates the measuring signal which is a sine wave by using a cosine wave signal and a sine wave signal of the first frequency to thereby generate the demodulated signal of a sine wave and a cosine wave, and the decimation filter removes the harmonic component to thereby output a sine wave signal and a cosine wave signal including the component of the second frequency and the cyclic error component.

4. The measuring apparatus according to claim 3, wherein, given that a correction value for the processing delay is τc, the processing delay correcting unit calculates a phase delay value using the following equation:
(phase delay value)=n×2π×fd×τc,
wherein, given that an amplitude of the cyclic error component is Vn, the initial phase of the cyclic error component is θn, and time is t, the signal generating unit generates a first removal signal and a second removal signal as the removal signals using the phase delay value using the following equations:
(first removal signal)=Vn×sin(n×2π×fd×t+n×2π×fd×τc+θn)
(second removal signal)=Vn×cos(n×2π×fd×t+n×2π×fd×τc+θn), and
wherein the removing unit removes the cyclic error component from the sine wave signal and the cosine wave signal, which are the outputs of the decimation filter, using the first removal signal and the second removal signal.

5. The measuring apparatus according to claim 1, further comprising:
a frequency calculating unit configured to calculate a change amount of a phase difference between the reference signal and the measuring signal or the change amount of the position of the target object based on the output signal from the decimation filter to thereby calculate the second frequency from the change amount.

6. The measuring apparatus according to claim 2, wherein the detector calculates the output signal from the decimation filter by Fourier transform to thereby calculate the amplitude of the cyclic error component and the initial phase of the cyclic error component.

7. The measuring apparatus according to claim 4, wherein the processing delay is a delay time consisting of a processing delay time τ1 occurred when a signal phase-locked to the cyclic error component is generated by the detector and the signal generating unit and a processing delay time τ2 occurred when the phase-locked signal is matched to the amplitude of the cyclic error component by the signal generating unit, and
wherein the correction value τc is represented by the following equation:
τc=τ1+2×τ2.

8. The measuring apparatus according to claim 5, wherein the detector comprises a plurality of decimation filters having different decimation frequencies for further decimating the output signal from the decimation filter, and the plurality of decimation filters is switched based on the value of the second frequency calculated by the frequency calculating unit.

9. The measuring apparatus according to claim 5, wherein the detector calculates the change amount of the second frequency correlating the acceleration of the target object from the second frequency calculated by the frequency calculating unit, and further includes a determining unit that switches updating or holding the amplitude of the cyclic error component and the value of the initial phase using the change amount.

10. The measuring apparatus according to claim 2, wherein the signal generating unit generates a sine wave signal and a cosine wave signal of the frequency of the cyclic error component using the second frequency, and the detector demodulates the output signal from the decimation filter using the sine wave signal and the cosine wave signal, removes a harmonic component from the demodulated signal, and calculates an amplitude and a phase of the cyclic error component from a signal from which the harmonic component has been removed.

11. The measuring apparatus according to claim 10, wherein the detector calculates the amplitude and the phase which is equal to the initial phase of the cyclic error component,
wherein, given that a correction value for the processing delay is τc, the processing delay correcting unit calculates a phase delay value using the following equation:
(phase delay value)=n×2π×fd×τc,
wherein, given that the amplitude is Vn, the phase is OFS, and time is t, the signal generating unit generates a first removal signal and a second removal signal as the removal signals using the phase delay value using the following equations:
(first removal signal)=Vn×sin(n×2n×fd×t+n×2π×fd×τc+OFS)
(second removal signal)=Vn×cos(n×2π×fd×t+n×2π×fd×τc+OFS), and
wherein the removing unit removes the cyclic error component from the sine wave signal and the cosine wave signal, which are the outputs of the decimation filter, using the first removal signal and the second removal signal.

12. The measuring apparatus according to claim 10, wherein the processing delay correcting unit delays the sine wave signal and the cosine wave signal, which are used for demodulation by the detector, by a correction value τc with respect to the processing delay,
wherein the detector demodulates the output signal from the decimation filter by using the sine wave signal and the cosine wave signal which has been delayed by the processing delay correcting unit, to thereby calculate the amplitude and the phase
wherein, given that the amplitude is Vn, the phase is OFS, and time is t, the signal generating unit generates a first removal signal and a second removal signal as the removal signals using the following equations:
(first removal signal)=Vn×sin(n×2π×fd×t+OFS)
(second removal signal)=Vn×cos(n×2π×fd×t+OFS), and
wherein the removing unit removes the cyclic error component from the sine wave signal and the cosine wave signal, which are the outputs of the decimation filter, using the first removal signal and the second removal signal.

13. The measuring apparatus according to claim 11, wherein the processing delay is a delay time consisting of a processing delay time τ1 occurred when a signal phase-locked to the cyclic error component is generated by the detector and the signal generating unit and a processing delay time τ2 occurred when the phase-locked signal is matched to the amplitude of the cyclic error component by the signal generating unit, and
wherein the correction value τc is represented by the following equation:
τc=τ1+2×τ2.

14. The measuring apparatus according to claim 12, wherein the processing delay is a delay time consisting of a processing delay time τ1 occurred when a signal phase-locked to the cyclic error component is generated by the detector and the signal generating unit and a processing delay time τ2 occurred when the phase-locked signal is matched to the amplitude of the cyclic error component by the signal generating unit, and
wherein the correction value τc is represented by the following equation:
τc=τ1+2×τ2.

15. The measuring apparatus according to claim 10, wherein the detector includes a plurality of filters having different bands for removing the harmonic component, and the plurality of filters is switched based on the value of the second frequency calculated by the frequency calculating unit.

16. The measuring apparatus according to claim 15, wherein the filter is a decimation filter or an LPF (Low Pass Filter).

17. The measuring apparatus according to claim 5, wherein the detector calculates the change amount of the second frequency correlating the acceleration of the target object from the second frequency calculated by the frequency calculating unit, and further includes a determining unit that switches updating or holding the amplitude and initial phase of the cyclic error component or the value of the phase using the change amount.

18. The measuring apparatus according to claim 1, further comprising:
a Phase Locked Loop configured to generate a signal of the first frequency used for demodulation by the demodulation unit from the reference signal.

19. The measuring apparatus according to claim 1, wherein the decimation filter is a CIC (Cascaded Integrator Comb) filter.
